(19) United States
(12) Patent Application Publication
(10) Pub. No.: US 2026/0307317 A1
(43) Pub. Date: Oct. 8, 2026

(54) HIGH PUNCTURE RESISTANT RECYCLABLE PACKAGING FILM WITH POLAR POLYMER OUTER LAYER

(71) Applicant: PROAMPAC HOLDINGS INC., Cincinnati, OH (US)

(72) Inventors: Ebrahim Jalali Dil, Montreal (CA); Seyed Hesamoddin Tabatabaei, Mason, OH (US); Amir Saffar, Laval (CA)

(21) Appl. No.: 19/571,763

(22) Filed: Mar. 19, 2026

Related U.S. Application Data
(60) Provisional application No. 63/774,985, filed on Mar. 20, 2025.

(51) Int. Cl. B29C 48/00; B29C 48/21; B29C 48/22; B29K 23/00; B29K 29/00; B29K 67/00; B29K 77/00; B29L 9/00; B29L 31/00

(52) U.S. Cl. CPC B29C 48/022; B29C 48/21; B29C 48/22; B29K 2023/00; B29K 2023/086; B29K 2029/04; B29K 2067/003; B29K 2077/00; B29K 2995/0053; B29K 2995/0059; B29K 2995/0081; B29L 2009/00; B29L 2031/712

(57) ABSTRACT

A puncture resistant, recyclable, polyolefin-based film structure includes at least one polar polymer component including an oriented polar polymer film outer layer having a maximum puncture force in the range of 15N-60N (ASTM F1306). The film includes at least one nonpolar polymer component comprising one or more polyolefin-based polymer layers, at least one of which comprises a functional polyolefin-based polymer configured to facilitate compatibility between at least one polar polymer component and nonpolar polymer component. The amount of functional polyolefin-based polymer in the polyolefin-based sealant layer is ≥30 wt. % of the weight of polar polymer components in the structure. Preferably, the functional polyolefin-based polymer is known to the flexible film industry as a tie resin for adhesion in multilayer structures, wherein the functional polyolefin-based polymer further acts as a compatibilizer to facilitate compatibility between the at least one polar polymer component and the at least one nonpolar polymer component.

### CROSS REFERENCE TO RELATED APPLICATION

This application claims the priority benefit of U.S. Provisional Patent Application No. 63/774,985 filed Mar. 20, 2025. The aforementioned application is incorporated herein by reference in its entirety.

### BACKGROUND

The present invention relates to flexible packaging films and, in particular, to recyclable, high toughness, high puncture resistant laminated film structures comprising a polar polymer outer layer.

High puncture plastic packaging has been a key player in several food packaging such as meat with bones packaging, nuts packaging, and pet food packaging. Among different polymers, polyesters, including polyethylene terephthalate (PET) polymers and polyamide polymers, e.g., nylon polymers, are known for their outstanding puncture resistance and are used commonly in puncture resistant barrier packaging. However, it has been shown that recycling of these packages is very challenging due to the presence of PET and Nylon components. Nonpolar polymers such as polyolefins and polar polymers such as nylon, ethylene vinyl alcohol copolymers (EVOH) and polyesters are generally not compatible in recycling processes due to immiscibility. This incompatibility leads to phase separation when melted during the recycling process where the polar polymers form discrete domains within the nonpolar matrix. These polar domains can aggregate, creating weak points in the recycled material, reducing mechanical properties, and leading to defects in the final product.

Accordingly, there exists a need for an improved high puncture packaging film that enhances recyclability without compromising toughness and puncture resistance.

Various advantages and benefits of the present invention will become apparent to those of ordinary skill in the art upon reading and understanding the following detailed description of the preferred embodiments.

### SUMMARY

In one aspect, a puncture resistant, recyclable, polyolefin-based film structure includes an outer layer comprising an oriented polar polymer film layer, wherein the outer layer has a maximum puncture force in the range of 15 N to 60 N, in accordance with ASTM F1306. A polyolefin-based sealant layer comprises a polyolefin polymer and a functional polyolefin based polymer, wherein the functional polyolefin based polymer acts as compatibilizer configured to facilitate compatibility between the polar polymer and the polyolefin polymer, wherein the amount of functional polyolefin based polymer in the polyolefin-based sealant layer is in the range of to 30% to 70% by weight based on the total weight of all polar polymer components in the film structure, and preferably in the range of to 30% to 55% by weight based on the total weight of all polar polymer components in the film structure.

In embodiments, the functional polyolefin comprises a commercially available functional polymer resin as known to persons skilled in the art in the flexible film industry for use as a tie-layer or tie resin. It has been found that when such tie resins are used in an amount equal to about 30% by weight or more based on the weight of polar polymer components in the overall film structure, such functional polymer resin will act as a compatibilizer to compatibilize the polar and nonpolar components, e.g., when the film structure undergoes recycling or reprocessing. The functional polyolefin based can be used in its pure form or as a blend of the functional polyolefin based polymer mixed with a polyolefin polymer.

The functional polyolefin based polymer can be added in any one or more film layers containing polyolefin, including any one or more polyolefin based core film layers, polyolefin based bonding interlayers, polyolefin based sealant layers, or any combination thereof. For example, in certain embodiments, a compatibilizing-effective of the functional polyolefin based polymer is added to a single layer of the film structure. In alternative embodiments, a compatibilizing-effective of the functional polyolefin based polymer is split between any two or more polyolefin containing layers (i.e., polyolefin based core layer(s), polyolefin-based bonding layer(s), or heat sealant layer(s) of the film structure.

The functional polyolefin based may be in the form of a grafted polymer or a random, block, or alternating copolymers where the term copolymer refers to a polymer made of at least two monomers. The functional polyolefin based polymer comprises a polyolefin functional with one or more functional groups selected from the group consisting of a carboxylic acid, an ester, an anhydride, an aldehyde, a ketone, an isocyanate, an epoxide, an acrylate, an alkene, an alkyne, a nitroso, an imide, a carbonate, a nitrile, an acid halide, a phosphoric acid derivative, an alkyl halide, a sulfonyl halide, an aziridine, a halogen, a carbene, and a sulfonic acid group.

In certain embodiments, the functional polyolefin includes:
(a) copolymers of alkylenes, preferably lower alkylene, and vinyl acetate, including but not limited to ethylene vinyl acetate (EVA), vinyl acetate ethylene (VAE), propylene vinyl acetate (PVA), and vinyl acetate propylene (VAP);
(b) copolymers of alkylenes, preferably lower alkylenes, and unsaturated carboxylic acids (preferably lower unsaturated carboxylic acids), including but not limited to ethylene-acrylic acid (EAA) copolymer, ethylene-methacrylic acid (EMAA) copolymer, propylene-acrylic acid copolymer, propylene-methacrylic acid copolymer, butylene-acrylic acid copolymer, butylene-methacrylic acid copolymer;
(c) copolymers of alkylenes, preferably lower alkylenes, and alkyl esters derived from unsaturated carboxylic acids (preferably lower alkyl esters derived from lower unsaturated carboxylic acids), including without limitation, ethylene-methyl acrylate copolymer (EMA), ethylene-ethyl acrylate copolymer (EEA), ethylene-propyl acrylate copolymer, ethylene-butyl acrylate copolymer (EBA), propylene-methyl acrylate copolymer, propylene-ethyl acrylate copolymer, propylene-propyl acrylate copolymer, propylene-butyl acrylate copolymer, ethylene-methyl methacrylate copolymer (EMMA), ethylene-ethyl methacrylate copolymer (EEMA), ethylene-propyl methacrylate copolymer, ethylene-butyl methacrylate copolymer (EBAM), propylene-methyl methacrylate copolymer, propylene-ethyl methacrylate copolymer, propylene-propyl methacrylate copolymer, propylene-butyl methacrylate copolymer;
(d) polyolefins grafted with carboxylic acids or anhydride derivatives, preferably polyolefins grafted with lower carboxylic acids or lower anhydride derivatives, including but not limited to polyethylene (PE) grafted with acrylic acid (AA) (PE-g-AA), polyethylene (PE) grafted with maleic anhydride (MA) (PE-g-MA) polyethylene (PE) grafted with methacrylic acid (MAA) (PE-g-MAA), polypropylene (PP) grafted with acrylic acid (AA) (PP-g-AA), polypropylene (PP) grafted with maleic anhydride (MA) (PP-g-MA), and polypropylene (PP) grafted with methacrylic acid (MAA) (PP-g-MAA);
(e) terpolymers of alkylenes, unsaturated carboxylic acids or alkyl esters derived therefrom, and anhydrides, more preferably terpolymers of lower alkylenes, lower unsaturated carboxylic acids or lower alkyl esters derived therefrom, and lower anhydrides, including but not limited to ethylene-butyl acrylate-maleic anhydride terpolymer, ethylene-acrylic acid-maleic anhydride terpolymer, ethylene-methacrylic acid-maleic anhydride terpolymer, ethylene-methyl acrylate-maleic anhydride terpolymer, ethylene-ethyl acrylate-maleic anhydride terpolymer, ethylene-propyl acrylate-maleic anhydride terpolymer, ethylene-methyl methacrylate-maleic anhydride terpolymer, ethylene-ethyl methacrylate-maleic anhydride terpolymer, ethylene-propyl methacrylate-maleic anhydride terpolymer, ethylene-butyl methacrylate-maleic anhydride terpolymer, propylene-acrylic acid-maleic anhydride terpolymer, propylene-methacrylic acid-maleic anhydride terpolymer, propylene-methyl acrylate-maleic anhydride terpolymer, propylene-ethyl acrylate-maleic anhydride terpolymer, propylene-propyl acrylate-maleic anhydride terpolymer, propylene-butyl acrylate-maleic anhydride terpolymer, propylene-methyl methacrylate-maleic anhydride terpolymer, propylene-ethyl methacrylate-maleic anhydride terpolymer, propylene-propyl methacrylate-maleic anhydride terpolymer, propylene-butyl methacrylate-maleic anhydride terpolymer; and
(f) any combinations of the foregoing.

In a more limited aspect, the film structure exhibits a recyclability property based on commercial recycling guidance, including but not limited to guidance established by the Association of Plastic Recyclers (APR), for example, wherein:
when the film structure is reprocessed to form a reprocessed material; and
when the reprocessed material is blended with a control polymer to produce a recycled blend comprising 50% by weight of the reprocessed material and 50% by weight of the control polymer; and
when a blended recycled film is formed from the recycled blend and a control film is formed from the control polymer;
the blended recycled film demonstrates no more than a 25% reduction as compared to the control film in any of:
a. puncture resistance as evaluated using dart impact testing, in accordance with ASTM D1709;
b. tear resistance in the machine direction (MD), in accordance with ASTM D1922; and

c. tear resistance in the transverse direction (TD), in accordance with ASTM D1922.

It will be recognized that film structures compatible with future releases of the APR guidance and/or with recycling guidance, rules, or regulations from other industry groups, regulatory agencies, or other relevant organizations, including future releases, are also contemplated herein.

In another more limited aspect, the functional polyolefin based polymer comprises a grafted polyolefin functional with one or more functional groups, which may be the same or different.

In another more limited aspect, polar polymer components in the film structure include the oriented polar outer polymer film layer and optionally one or more polar polymer barrier layers in the film structure.

In another more limited aspect, the outer layer comprises a film selected from the group consisting of biaxially oriented nylon (BON), cast nylon, oriented polyethylene terephthalate (OPET), and biaxially oriented polyethylene terephthalate (BOPET).

In another more limited aspect, the film structure further comprises a bonding interlayer selected from the group consisting of an adhesive layer and an extrusion interlayer disposed intermediate the outer layer and the polyolefin-based sealant layer.

In another more limited aspect, the polyolefin-based sealant layer comprises an inner sealant layer and at least one intermediate film layer disposed between the oriented film outer layer and the inner sealant layer.

In another more limited aspect, the polyolefin-based sealant layer comprises an inner sealant layer and at least one barrier layer disposed between the oriented film outer layer and the inner sealant layer.

In another more limited aspect, the at least one barrier layer is selected from the group consisting of an inorganic barrier layer and a polymeric barrier layer.

In another more limited aspect, the inorganic barrier layer is selected from the group consisting of an aluminum oxide (AlOx) coating layer, a silicon oxide (SiOx) coating layer, and a metallized deposition layer.

In another more limited aspect, the polymeric barrier layer is selected from the group consisting of a polyvinyl alcohol (PVOH) layer, an ethylene vinyl alcohol copolymer (EVOH) layer, a polyamide layer, or a combination thereof.

In some embodiments, an inorganic barrier layer is provided on the polar polymer outer layer. In embodiments, the inorganic barrier layer is disposed on the exterior facing surface of the polar polymer outer layer. In alternative embodiments, the inorganic barrier layer is disposed on the interior facing surface of the polar polymer outer layer.

In another more limited aspect, the polyolefin-based sealant layer comprises an inner sealant layer, an outer sealant layer, and optionally one or more barrier layer disposed between the inner sealant layer and the outer sealant layer.

In some embodiments, the film structure includes one or more polyolefin-based core film layers.

In certain embodiments, the polyolefin-based polymer of the polyolefin-based core layers and the sealant layer comprises a polymer selected from the group consisting of polyethylene (PE), polypropylene (PP), polyolefin blends, polyolefin copolymers, low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cyclic olefin copolymer (COC), cast polypropylene (CPP), ethylene-propylene copolymer (EPC), monoaxially- and biaxially-oriented polyolefins, biaxially oriented polypropylene (BOPP), and other polyolefin materials, post-consumer recycled (PCR) polyolefins, as well as blends, coextrusions, and laminations of any of the foregoing.

In another more limited aspect, the polyolefin-based layer comprises a polymer coextrusion comprising a first coextrusion layer comprising a polyolefin admixed with the functional polyolefin based polymer; a second coextrusion layer comprising a polyolefin admixed with the functional polyolefin based polymer; and a coextrusion barrier layer disposed intermediate the first and second coextrusion layers.

In another more limited aspect, the film structure further comprises a first tie layer disposed intermediate the first coextrusion layer and the coextrusion barrier layer and a second tie layer disposed intermediate the second coextrusion layer and the coextrusion barrier layer.

In another more limited aspect, the coextrusion barrier layer comprises one or more polymers selected from the group consisting of polyvinyl alcohol (PVOH), ethylene vinyl alcohol copolymer (EVOH), and nylon.

In another more limited aspect, the functional polyolefin based polymer comprises a functional polyolefin with one or more functional groups, which may be the same or different, selected from the group consisting of a carboxylic acid, an ester, an anhydride, an aldehyde, a ketone, an isocyanate, an epoxide, an acrylate, an alkene, an alkyne, a nitroso, an imide, a carbonate, a nitrile, an acid halide, a phosphoric acid derivative, an alkyl halide, a sulfonyl halide, an aziridine, a halogen, a carbene, and a sulfonic acid group.

In another more limited aspect, the functional polyolefin based polymer comprises a functional polyolefin with one or more same or different functional groups, which may be the same different, selected from the group consisting of a carboxylic acid, an ester, an anhydride, an acrylate, an aldehyde, a ketone, an isocyanate, an epoxide, an alkene, an alkyne, and a nitroso group.

In another more limited aspect, packaging articles formed of the film structures herein are provided.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a side cross sectional view of a first exemplary embodiment laminated film structure in accordance with the present disclosure.

FIG. 2 is a side cross sectional view of a second exemplary embodiment laminated film structure in accordance with the present disclosure.

FIG. 3 is a side cross sectional view of a first exemplary polyolefin based sealant layer.

FIG. 4 is a side cross sectional view of a first exemplary polyolefin based core layer.

FIG. 5 is a side cross sectional view of a second exemplary polyolefin based sealant layer.

FIG. 6 is a side cross sectional view of a second exemplary polyolefin based core layer.

FIG. 7 is a side cross sectional view of a third exemplary polyolefin based sealant layer.

FIG. 8 is a side cross sectional view of a third exemplary polyolefin based core layer.

FIG. 9 is a side cross sectional view of a fourth exemplary polyolefin based sealant layer.

FIG. 10 is a side cross sectional view of a fourth exemplary polyolefin based core layer.

FIG. 11 is a side cross sectional view of a fifth exemplary polyolefin based sealant layer.

FIG. 12 is a side cross sectional view of a fifth exemplary polyolefin based core layer.

FIG. 13 is a side cross sectional view of a sixth exemplary polyolefin based sealant layer.

FIG. 14 is a side cross sectional view of a sixth exemplary polyolefin based core layer.

FIG. 15 is a side cross sectional view of a seventh exemplary polyolefin based sealant layer.

FIG. 16 is a side cross sectional view of a seventh exemplary polyolefin based core layer.

FIG. 17 is a first exemplary multi-layer barrier structure that may serve as either the sealant layer appearing in FIGS. 1 and 2 or the middle layer appearing in FIG. 1.

FIG. 18 is a second exemplary multi-layer barrier structure that may serve as either the sealant layer appearing in FIGS. 1 and 2 or the middle layer appearing in FIG. 1.

FIG. 19 is a third exemplary multi-layer barrier structure that may serve as either the sealant layer appearing in FIGS. 1 and 2 or the middle layer appearing in FIG. 1.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

The term “directly contacts,” “in direct contact with,” “directly adhered to,” or similar terms as used herein, refers to a layer configuration whereby a first layer is located immediately adjacent to a second layer, the first layer touches the second layer, and no intervening layers, and/or no intervening structures, are present between the first layer and the second layer. The terms “indirectly contacts” or “in indirect contact with,” or similar terms as used herein, refers to a layer configuration whereby an intervening layer, or an intervening structure, is present between the first layer and the second layer.

As used in this application, the terms “front,” “rear,” “upper,” “lower,” “upwardly,” “downwardly,” “left,” “right,” and other orientation descriptors are intended to facilitate the description of the exemplary embodiment(s) of the present invention and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5). Accordingly, unless indicated to the contrary, the numerical parameters set forth in the present specification and attached claims are approximations that can vary depending upon the desired properties sought to be obtained by the presently disclosed subject matter.

As used herein, the term “about,” when referring to a value can encompass variations of, in some embodiments ±20%, in some embodiments ±10%, in some embodiments ±5%, in some embodiments ±1%, in some embodiments ±0.5%, in some embodiments ±0.1%, and in some embodiments to +0.01%, from the specified amount, as such variations are appropriate in the disclosed materials and methods.

The terms “outer” and “inner” are used herein to refer to a position in relation to a product to be packaged using the multilayer packaging structures herein, while the terms “exterior” and “interior” are used herein to refer to a position in relation to other layers of the multilayer packaging structures herein.

As used herein, the term “outer” in connection with a layer or a ply refers to a layer or ply of a multilayer packaging structure which is furthest from the product to be packaged in relation to the other layers of the multilayer structure. The term “outward facing surface” of a layer of a multilayer packaging structure is the surface of such layer that faces away from the product being packaged within a multilayer packaging structure herein or a packaging article formed thereof. The term “outer surface” of a multilayer packaging structure is the surface of the structure that is intended to face away from a product being packaged within the structure.

As used herein, the term “inner” in connection with a layer or a ply refers to a layer or ply of a multilayer packaging structure which is closest to or is intended to contact the product to be packaged within a multilayer structure herein in relation to the other layers of the multilayer structure. The term “inward facing surface” of a layer or ply of a multilayer packaging structure herein is the surface of such layer that is intended to face toward the product being packaged within a multilayer packaging structure herein or a packaging article formed thereof. The term “inner surface” of a multilayer packaging structure herein is the surface of the structure that faces toward or is intended to face toward or contact a product being packaged within the structure.

As used herein, the term “interior” in connection with a layer or a ply refers to a layer or ply within a multilayer packaging structure herein is that is not exposed to handling and the environment. Interior layers may provide functionality as needed for particular applications. For example, interior layers may provide barrier protection and/or structural strength. As an example, an exemplary interior layer provides protection to packaged food or other product for freshness and/or a barrier to moisture and/or oxygen, and/or a barrier to migration of moisture, oils, and the like from packaged food or other product from the inner surface of the multilayer packaging structure to the outer surface of the multilayer packaging structure. As another example, an interior layer may also be a structural layer which provides one or more properties including but not limited to general durability, puncture strength, resistance to deformation, tear or flex crack resistance, and the like.

As used herein, the term “exterior” in connection with a layer or a ply refers to a layer or ply which comes in immediate contact with the outside environment or atmosphere. Therefore, the multilayer packaging structures herein have two exterior layers, namely, the inner layer and the outer layer.

As used herein, the term “extrusion” is used with reference to the process of forming shapes such as a melt curtain by forcing a molten plastic material through a die, followed by cooling or chemical hardening. Immediately prior to extrusion through the die, the polymeric material is fed into a rotating screw, i.e., an extruder that forces the polymeric material through the die. The term “continuous extrusion” refers to an extrusion process wherein the die is designed to produce a continuous flow or curtain of molten polymer without breaks or gaps. The term “discontinuous extrusion” refers to an extrusion process wherein the die is designed to produce a patterned or otherwise discontinuous flow or curtain of molten polymer. For example, the die may have multiple orifices that allow the polymer to be extruded in a pattern or with gaps in between extruded portions.

As used herein, the term “extrusion coating” is used in reference to a process wherein a molten polymer is extruded through a die and applied as a coating onto a substrate to form a coated substrate.

As used herein, the term “extrusion lamination” is used in reference to a process where a molten polymer is extruded through a die and then immediately laminated onto a first substrate and passes through a nip between the extrusion die and a second substrate, wherein the molten polymer forms an extrusion interlayer and bonds the two substrates together to form a laminated structure.

As used herein, the term “coextrusion” refers to the process of extruding two or more materials through a single die with two or more orifices arranged so that the extrudates merge and weld together into a laminar structure before chilling, i.e., quenching.

As used herein, the terms “packaging structure,” “packaging film structure,” and the like refer to a web of sheet material having a structure as disclosed herein, as well as a packaging article manufactured therefrom, including sheets or wraps, bags, pouches, and the like.

As used herein, the term “polar polymer” refers to a polymer that contains electronegative groups or polar functional groups such as hydroxyl groups, carbonyl groups, carboxyl groups, carboxylate groups, ester groups, amide groups, ether groups, nitrile groups, or similar groups. These groups impart polarity to the polymer, such as an ability to form hydrogen bonds or polar/polar interactions, resulting in an increased affinity for polar substances. Examples of polar polymers include, but are not limited to, polyamides, ethylene vinyl alcohol copolymer (EVOH), polyesters, acrylates, and copolymers or blends thereof.

As used herein, the term “functional polymer” refers to a polymer that has been chemically or physically modified in relation to a nonfunctional polymer to include one or more functional groups, reactive sites, or structural features that alter its chemical, physical, or mechanical properties, wherein such modifications may occur during polymerization, through post-polymerization treatment, or by incorporation of functional monomers or moieties. In certain embodiments, the functional polymer is a polymer that has been modified through post-polymerization chemical modification. In certain embodiments, the functional polymer is a polymer that has been modified through grafting to introduce of one or more grafted functional groups. In other embodiments, the functional polymer is a polymer that has been made functional through direct polymerization of functional monomers, end-group functionalization, or copolymerization with functional comonomers (including but not limited to block copolymerization, random copolymerization, and alternating copolymerization).

As used herein, the term “oriented” refers to polymer films that have been subjected to a stretching process either during film extrusion or post-extrusion to align the polymer chains in one or more directions. The term includes both monoaxially oriented films, where the polymer chains are aligned predominantly in one direction, and biaxially oriented films, where the polymer chains are aligned in two perpendicular directions. Oriented films are typically characterized by one or more improved mechanical properties, such as strength, clarity, tensile strength, heat resistance, abrasion resistance, puncture resistance, barrier properties, dimensional stability, and improved performance in Gelbo Flex testing, as compared to non-oriented films.

As used herein, the term “recyclability standards setting organization” refers to an entity that establishes standards, criteria, guidelines, or certifications for the recyclability of materials based on factors including but not limited to reprocessing compatibility and the mechanical performance of recycled materials derived from the original materials. Exemplary recyclability standards setting organizations include but are not limited to Association of Plastic Recyclers (APR), ASTM International, International Organization for Standardization (ISO), How2Recycle, Canadian Standards Association (CSA Group), and European Committee for Standardization (CEN).

As used herein, the term “recyclability standard” refers to a set of criteria specifying how a material must perform after recycling, including without limitation, requirements related to mechanical property retention in the recycled materials derived from the original materials.

As used herein, the term “recyclability property” refers to a property of a material that indicates its suitability for recycling, including but not limited to reprocessing compatibility, mechanical property retention after reprocessing, including mechanical property retention in a reprocessed blended material.

All compositional percentages used herein are presented on a “by weight” basis, unless specifically stated otherwise.

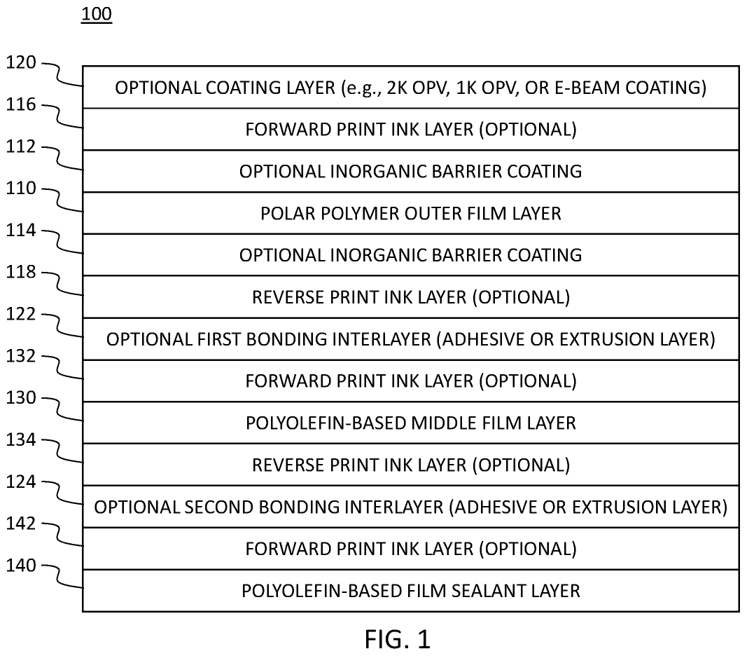

Referring now to FIG. 1, there is shown an exemplary packaging film structure film structure 100 which includes an outer film layer 110 which is laminated to a polyolefin-based middle film layer 130 and a polyolefin-based sealant layer 140. In certain embodiments, the outer film layer 110 and the middle film layer 130 are laminated via an optional first bonding interlayer 122 disposed intermediate the outer layer 110 and the polyolefin-based middle film layer 130. In certain embodiments, the middle film layer 130 and the polyolefin-based sealant layer 140 are laminated via an optional second bonding interlayer 124 disposed intermediate the middle film layer 130 and the polyolefin-based middle film layer 140.

In embodiments having the first bonding interlayer 122 and/or the second bonding interlayer 124, such layers may be an adhesive layer or an extruded polymer interlayer and the structure 100 can be formed using conventional lamination techniques, such as adhesive lamination or extrusion lamination techniques.

When the first bonding interlayer 122 and/or the second bonding interlayer 124, which may be the same or different, is an adhesive, an adhesive layer is applied between the plies 110 and 130 in the case of the first bonding interlayer 122 and between the plies 130 and 140 in the case of the second bonding interlayer 124 and the plies 110 and 130 and/or the plies 130 and 140 are bonded under suitable conditions. The adhesive may be applied to the surface of at least one of the plies 110 and 130 (in the case of the first bonding interlayer 122) and/or the plies 130 and 140 (in the case of the second bonding interlayer 124) via any suitable coating method, e.g., spray coating, roll coating, blade coating, or similar technique. The adhesive may be any suitable adhesive, including single component adhesives, two component adhesives, solvent-based adhesives, solventless adhesives, water-based adhesives, acrylic adhesives, polyurethane adhesives, electron beam lamination adhesives, and UV lamination adhesives, as would be understood by persons skilled in the art.

In certain embodiments, the adhesive lamination process comprises a first lamination step in which the outer layer 110 is laminated to the middle layer 130 in one lamination step and a second lamination step wherein the middle layer 130 is laminated to the sealant layer 140. Alternatively, the outer layer 110, middle layer 130, and inner layers 140 may be laminated in a single process line.

When the first bonding interlayer 122 and/or the second bonding interlayer 124, which may be the same or different, is an extrusion interlayer, the first bonding interlayer 122 is extruded and brought onto a surface of one of the plies 110 and 130 and/or the second bonding interlayer 124 is extruded and brought onto a surface of one of the plies 130 and 140 as a melt curtain, e.g., just before the nip of lamination rollers, to laminating the plies 110 and 130 (in the case of the first bonding interlayer 122) and/or the plies 130 and 140 (in the case of the second bonding interlayer 124). In embodiments wherein the first bonding interlayer 122 and/or second bonding interlayer 124 is an extruded polymer interlayer, the polymer may be any suitable polymer used for extrusion lamination, including low-density polyethylene (LDPE), linear low-density polyethylene (LLDPE), high-density polyethylene (HDPE), polypropylene (PP), ethylene-vinyl acetate (EVA), ethylene-methyl acrylate (EMA), ethylene-acrylic acid (EAA), ethylene-methacrylic acid (EMAA), ethylene-methyl methacrylate (EMMA), ionomers, and blends thereof, as would be understood by persons skilled in the art.

In embodiments lacking the optional first bonding interlayer 122, the polyolefin-based middle layer is applied directly onto the inner surface of the outer layer 110 using an extrusion or coextrusion process. In embodiments lacking the optional second bonding interlayer 124, the polyolefin-based sealant layer is applied directly onto the inner surface of the middle layer 130 using an extrusion or coextrusion process.

When the first and/or second bonding interlayer 122, 124 is an extrusion layer, it is preferably a polyolefin based polymer. When the first and/or second bonding interlayer 122, 124 comprises a polyolefin based polymer, it may optionally contain a functional polyolefin based polymer as defined herein.

Table 1 below illustrates the various permutations for the first and second optional bonding interlayers 122, 124:

TABLE 1

| First Bonding Interlayer 122 | Second Bonding Interlayer 124 |
|---|---|
| None (direct bond via ext. or coext. coating) | None (direct bond via ext. or coext. coating) |
| None (direct bond via ext. or coext. coating) | Adhesive |
| None (direct bond via ext. or coext. coating) | Extruded Polymer |
| Adhesive | None (direct bond via ext. or coext. coating) |
| Adhesive | Adhesive |
| Adhesive | Extruded Polymer |
| Extruded Polymer | None (direct bond via ext. or coext. coating) |
| Extruded Polymer | Adhesive |
| Extruded Polymer | Extruded Polymer |

In embodiments, an optional inorganic barrier coating layer 112 may be provided on the outward facing surface of the outer film layer 110 and/or an optional inorganic barrier coating layer 114 may be provided on the inward facing surface of the outer film layer 110. In embodiments, the inorganic barrier layer 112, 114 may be a metallization layer, such as aluminum, or a metal oxide coating layer, such as aluminum oxide (AlOx), silicon oxide (SiOx), or a mixture thereof. In embodiments, the metallization layer may be formed using a physical or chemical deposition technique. In embodiments, the metal oxide coating layer may be deposited using physical or chemical deposition techniques or a solution coating technique.

In the illustrated embodiment, an optional ink layer 116 may be disposed on the outer surface of the outer layer 110 and/or an optional ink layer 118 may be disposed on the inner surface of the outer layer 110. An optional outer coating layer 120 may be provided on outer layer 110, preferably as the outermost surface of the film structure 100.

Other configurations are also contemplated. In embodiments, any one or more of the inorganic barrier coating layers 112, 114 and the ink layers 116, 118 may be omitted. In embodiments, the optional ink layer 112 is disposed on the outer surface of the outer layer 110, e.g., applied as forward printing. In embodiments, the optional ink layer 114 is disposed on the inner surface of the outer layer 110, e.g., applied as reverse printing.

The optional ink layers 116, 118 can be applied via any conventional printing method as would be understood by persons skilled in the art, including without limitation, using a rotogravure printing apparatus, flexographic printing apparatus, offset printing apparatus, digital printing apparatus, ink jet printing apparatus, and the like. The ink layers 116, 118 may comprise a water-based or solvent based ink compositions as would be understood by persons skilled in the art.

The outer layer 110 comprises a polar polymer film and, in preferred embodiments, an oriented polar polymer film. In certain embodiments, the outer layer 110 comprises a blown or cast polar polymer film, with or without any additional stretching or orientation of the film after the initial blown or cast film extrusion process. The outer layer 110 may be a monolayer or multilayer structure. In embodiments, the outer layer 110 is formed of at least one polar polymer selected from polyamides, polyesters, or combination thereof, e.g., as a blended mixture or coextruded layers. In embodiments, the outer layer 110 comprises a polyamide. Exemplary polyamides include, but are not limited to, nylons such as cast nylon, nylon 6, nylon 66, nylon 6/66, nylon 12, and blends and copolymers thereof. In embodiments, the outer layer 110 is biaxially oriented nylon (BON) or monoaxially oriented nylon. In embodiments, the outer layer 110 is formed of a polyester, including without limitation oriented polyethylene terephthalate (OPET), and biaxially oriented polyethylene terephthalate (BOPET).

In embodiments, the outer layer 110 is formed of polyamide which has been formed into a film by a cast film process. In embodiments, the outer layer 110 is formed of cast nylon film. In embodiments, the outer layer 110 is formed of polyamide which has been formed into a film by a cast film process and oriented either during film casting or post casting. In embodiments, the outer layer 110 is formed of oriented cast nylon, e.g., oriented cast nylon 6, oriented cast nylon 66, oriented cast nylon 6/66, oriented cast nylon 12, and blends and copolymers thereof. In embodiments, the outer layer 110 is formed of polyamide which has been formed into a film by a cast film process without any stretching either during film casting or post casting. In embodiments, the outer layer 110 is formed of non-oriented cast nylon film, e.g., non-oriented cast nylon 6, non-oriented cast nylon 66, non-oriented cast nylon 6/66, non-oriented cast nylon 12, and blends and copolymers thereof.

In embodiments, the outer layer 110 is formed of polyamide which has been formed into a film by a blown film process, including single bubble, double bubble, and triple bubble formation processes. In embodiments, the outer layer 110 is formed of blown polyamide film. In embodiments, the outer layer 110 is formed of blown nylon film, e.g., blown nylon 6, blown nylon 66, blown nylon 6/66, blown cast nylon 12, and blends and copolymers thereof. In embodiments, the outer layer 110 is formed of polyamide which has been formed into a film by a blown film process and further oriented or stretched after the blown film extrusion process. In embodiments, the outer layer 110 is formed of polyamide which has been formed into a film by a blown film process without any further stretching after the blown film extrusion process.

In certain embodiments, the polar polymer utilized for the outer layer 110 comprises a polyester. Exemplary polyesters include, but are not limited to, polyethylene terephthalate (PET), polybutylene terephthalate (PBT), and copolymers or blends thereof. In embodiments, the outer layer 110 is oriented PET (OPET) or biaxially oriented PET (BOPET).

The polyolefin-based middle layer 130 and the polyolefin based sealant layer 140 may independently comprise a monolayer or multilayer structure. The term “polyolefin based” refers to a polymer composition comprising a polymer selected from the group consisting of homopolymers and copolymers of olefins, including but not limited to ethylene, propylene, butylene, and mixtures thereof, as well as functional polyolefins, where the polyolefin polymer or functional polyolefin constitutes a majority of the composition.

The polyolefin based middle layer 130 and the polyolefin based sealant layer 140 each independently comprise a polyolefin-based polymer composition. Exemplary polyolefin components of the polyolefin based middle layer 130 and the polyolefin based sealant layer 140 include, but are not limited to, polyethylene (PE), polypropylene (PP), polybutene (PB), polyolefin blends, or polyolefin copolymers. In embodiments, the nonpolar polymer component(s) of the polyolefin-based sealant layer 120 comprises low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cyclic olefin copolymers (COC), cast polypropylene (CPP), ethylene-propylene copolymer (EPC), monoaxially- and biaxially-oriented polyolefins including without limitation biaxially oriented polypropylene (BOPP), and other polyolefin materials, including post-consumer recycled (PCR) polyolefins, as well as blends, coextrusions, and laminations of any of the foregoing. In the case of the polyolefin based sealant layer 140, at least the exterior most layer (i.e., product facing surface) is a heat sealable polyolefin layer, i.e., configured to form a hermetic seal with itself or similar surfaces under predetermined sealing conditions, i.e., sealing temperature, sealing pressure, and dwell time.

In embodiments, the nonpolar polymer component(s) of the polyolefin-based middle layer 130 and the polyolefin based sealant layer 140 may be a copolymer of polyethylene and polypropylene, such as an ethylene-propylene copolymer. In embodiments, the nonpolar polymer component(s) of the polyolefin-based middle layer 130 and the polyolefin-based sealant layer 140 may be a coextruded film with a barrier layer and optional tie resin layers as would be understood by persons skilled in the art. In embodiments, the barrier layer is selected from ethylene vinyl alcohol copolymer (EVOH), polyamide (PA), such as nylon 6, nylon 66, nylon 6/66, PVOH, and the like. In embodiments, the polyolefin component or components of the polyolefin-based middle layer 130 and the polyolefin based sealant layer 140 may comprise one or more functional polyolefin-based polymers.

In preferred embodiments, the coating layer 120 is selected from the group consisting of an energy cured coating, a two-part coating, a one part overprint varnish (OPV) coating or overprint lacquer coating, or a heat sealable coating. The term “energy-cured coating” refers to a coating of one or more reactive monomer, oligomer, or polymer compositions, which is irreversibly converted into a solid polymer coating via reactive groups in the reactive monomer, oligomer, or polymer compositions upon the application of energy from a suitable energy source, such as irradiation with electron beams or irradiation with electromagnetic radiation, such as ultraviolet (UV) light or thermal radiation (heat).

In embodiments, the coating layer 120 is a cured polyacrylate composition formed from by curing a reactive polymer composition comprising one or more monomers, oligomers, polymers, acrylates, polyacrylates, and/or polyacrylate copolymers. In certain embodiments, the coating layer 120 is an electron beam cured composition that includes, but is not limited to, ethoxylated trimethylolpropane triacrylates, acrylates and acrylate ester resins, polyol acrylates, trimethylolpropane triacrylates, polydimethylsiloxane acrylates, and maleic anhydrides. Other energy-cured coating compositions may include monomers and oligomers that contain vinyl and allyl compounds, as well as monomers and oligomers that are induced into UV polymerization and curing through the mediation of photoinitiators and exposure to UV light and coatings that provide enhanced oxygen and moisture barrier properties.

In certain embodiments, the energy-cured coating has a coating thickness in the range of from about 0.78 micron (0.03 mil) to about 8 microns (0.31 mil), preferably from about 2.3 microns (0.091 mil) to about 4.7 micron (0.19 mil). In certain embodiments the energy-cured coating has a density in the range of from about 0.85 g/cc to about 1.25 g/cc, preferably from about 1.02 to about 1.06 g/cc, and most preferably about 1.04 g/cc. In certain embodiments, the energy-cured coating has a coating weight in the range of from about 0.5 lb/ream (0.81 g/m²) to about 5.0 lb/ream (8.14 g/m²), preferably of from about 1.5 lb/ream (2.44 g/m²) to about 3.0 lb/ream (4.88 g/m²).

In embodiment the outer layer 120 comprises a two-part coating formed through the polymerization of two starting components, namely, a cross-linkable binder component and a cross-linking agent component, wherein the cross-linkable binder component and the cross-linking agent component are combined to form a coating composition prior to application to the film construction and wherein the reactive constituents thereof combine through a curing process.

In embodiments, the outer layer 120 is a two-part coating formed from a coating composition comprising a cross-linkable binder and cross-linking agent, wherein the coating composition is curable at room temperature. In embodiments, the coating composition has a full curing time in the range of from about 1-15 days. The cross-linking agent chemically reacts with the cross linkable agent and, since reactions begin as soon as the cross-linkable binder and the cross-linking agent are mixed, the two-part coating is preferably mixed in batches and brought to the press.

The cross-linking agent comprises an isocyanate compound having at least one isocyanate group (R—N═C═O), such as 1,6-hexane diisocyanate (HDI), toluene diisocyanate (TDI), hexamethylene-di-isocyanate. The cross-linkable binder comprises a polymer selected from nitrocelluloses, polyesters, and polyurethanes. In embodiments, the polyurethane is a polyurethane having hydroxyl functional groups. In embodiments, the ratio of the cross-linkable binder to the cross-linking agent in the coating mixture is in the range of 100:10 to 100:40, by weight.

In embodiments, the two-part coating is applied using a printer at high speed, e.g., 100-500 m/min. After applying the coating, the coated film is passed through oven/dryer to remove the solvent and the wound up on a take up roll with minimum tension on the roll to avoid passing volatile organic liquids from the coating layer to other side of the roll. The roll is then set aside to complete the curing and reaction, e.g., for 1-15 days depending on the cure time of the two-part coating composition.

In embodiments, the coating weight of the mixed coating is in the range of 0.75 pounds per ream (1.22 grams per square meter) to 3 pounds per ream (4.88 grams per square meter) dry weight and more preferably in the range of 1.0 pounds per ream (1.63 grams per square meter) to 1.5 pounds per ream (2.44 grams per square meter) dry weight. Solvents for the cross-linkable binder and cross-linking agent include alcohols and esters, including without limitation, isopropanol, ethyl acetate, and n-propyl acetate. The two-part coating is commercially available through different industrial coating suppliers such as Sun Chemical Corporation of Parsippany, NJ, J. M. Huber Corporation of Edison, NJ, Siegwerk Druckfarben AG & Co. KGaA of Siegburg, Germany, DAW SE of Ober-Ramstadt, Germany, and others. The two-part coating provides a similar melting resistance to the outer surface of the film structures as the energy-cured coatings herein.

In certain embodiments, the coating layer 120 is an overprint varnish or lacquer coating as would be understood by persons skilled in the art.

In certain embodiments, the coating layer 120 is a heat sealable coating layer configured for heat sealing with a polymer such as polyethylene, polypropylene, polystyrene, or nylon. Exemplary heat sealable coating layers include but are not limited to ethylene-vinyl acetate (EVA), ethylene acrylic acid (EAA), ethylene-methyl acrylate (EMA) copolymers, ethylene-methacrylic acid copolymer (EMAA), ethylene-butyl acrylate-maleic anhydride terpolymer, and the like.

The polyolefin-based middle layer 130 may be a monolayer or multilayer structure and optionally includes a moisture vapor barrier layer, an oxygen barrier layer, or both. In preferred embodiments, the innermost surface of the polyolefin-based sealant layer 140 comprises a heat-sealable polymer configured to form a hermetic seal with itself or similar surfaces under predetermined sealing conditions, i.e., sealing temperature, sealing pressure, and dwell time.

In embodiments wherein the outer layer 110 and the polyolefin-based middle layer 130 are extrusion or adhesive laminated, the optional ink layer 132 may disposed on the outer surface of the middle layer 130, e.g., applied as forward printing. In certain embodiments, an optional ink layer 134 is applied to the inward facing surface of the middle film layer 130, e.g., effective in reverse print.

In embodiments, the polyolefin-based middle layer 130 comprises a polyolefin polymer admixed with a functional polyolefin-based polymer. The functional polyolefin based polymer exhibits a compatibilization property that facilitates compatibility between polar polymers in the structure 100, including but not limited to the polar polymer outer layer 130, and the non-polar polyolefin based polymers contained in the structure 100. The polyolefin-based middle layer 130 may be a monolayer or multilayer structure and optionally includes a moisture vapor barrier layer, an oxygen barrier layer, or both.

In embodiments, the functional polyolefin based polymer comprises a polyolefin-based polymer or copolymer system which has been functional, e.g., through grafting or copolymerization with one or more functional groups, as described above. In embodiments, the functional polyolefin based polymer comprises a polyolefin-based polymer or copolymer system which has at least two different functional groups. In embodiments, the grafted functional group(s) is configured to enhance the miscibility or compatibility of polar and nonpolar polymers and reduce the aggregation of polar polymer phase domains within a nonpolar polymer matrix to facilitate the formation of more homogeneous blends during melting and extrusion stages of the recycling process, enabling the efficient reprocessing of polymer materials containing both nonpolar and polar polymer components.

In certain embodiments, the polyolefin-based polymer system comprises polyethylene, polypropylene, or blends or copolymers thereof. The presence of one or more functional groups allows the compatibilizer to exhibit a compatibilization property between different polar polymers and non-polar polyolefins. In embodiments, the functional polyolefin based polymer comprises one or more functional groups, which may comprise (a) a polyolefin-based polymer system which is functional through grafting with two or more different functional groups on the same polymer chain or molecule; (b) a blend of two or more polyolefin-based polymers, each of which has been functional through grafting with a same or different functional group; (c) a copolymer of an olefin with at least one more functional monomer, or (d) a combination thereof.

In embodiments, the functional polyolefin based polymer comprises a polyolefin-based polymer system which is functional, e.g., through grafting or copolymerization, with one or more functional groups selected from the group consisting of a carboxylic acid, an ester, an anhydride, an aldehyde, a ketone, an isocyanate, an epoxide, an acrylate, an alkene, an alkyne, a nitroso, an imide, a carbonate, a nitrile, an acid halide, such as an acid chloride, a phosphoric acid derivative, including esters, anhydrides and salts of phosphoric acid, an alkyl halide, a sulfonyl halide, such as a sulfonyl chloride, an aziridine, a halogen, such as chlorine, bromine, and iodine, a carbene, and a sulfonic acid group.

In preferred embodiments, the functional polyolefin based polymer comprises a polyolefin-based polymer system which is functional, e.g., through grafting or copolymerization, with one or more functional groups selected from the group consisting of a carboxylic acid, an acrylate, an ester, an anhydride, an aldehyde, a ketone, an isocyanate, an epoxide, an alkene, an alkyne, and a nitroso group.

In certain embodiments, the functional polyolefin based polymer is a low molecular weight polymer, e.g., wherein the molecular weight is below about 50,000 g/mol. In certain embodiments, the functional polyolefin based polymer is a medium molecular weight polymer, e.g., wherein the molecular weight is in the range of from about 50,000 g/mol to about 200,000 g/mol. In certain embodiments, the functional polyolefin based polymer is a high molecular weight polymer, e.g., wherein the molecular weight is in the range of from about 200,000 g/mol to about 3,000,000 g/mol. In certain embodiments, the functional polyolefin based polymer is an ultra-high molecular weight polymer, e.g., wherein the molecular weight is above about 3,000,000 g/mol, e.g., up to about 10,000,000 g/mol or higher, depending on synthesis and processing constraints.

The amount of functional polyolefin based polymer to be incorporated into polyolefin-based sealant layer 120 will vary directly with the concentration or quantity of polar groups present in the overall structure 100. It will be recognized that polar polymers are present not only in the outer layer 110 as described above, but may also be present, e.g., in any optional barrier layer in the polyolefin-based sealant layer 120 as described below. In preferred embodiments, the amount of functional polyolefin based polymer in the polyolefin-based sealant layer 120 is in the range of from about 30% to about 70% by weight, more preferably 30% to 55% by weight of the polar polymers in the structure 100, e.g., 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, or more, by weight of the polar polymers in the structure 100 or any subrange thereof.

In embodiments wherein the middle layer 130 and the polyolefin-based sealant layer 140 are extrusion or adhesive laminated, an optional ink layer 142 may disposed on the outward facing surface of the polyolefin-based sealant layer 140, e.g., applied as forward printing. The ink layer 142 may be as described above by way of reference to the optional ink layers 116 and 118.

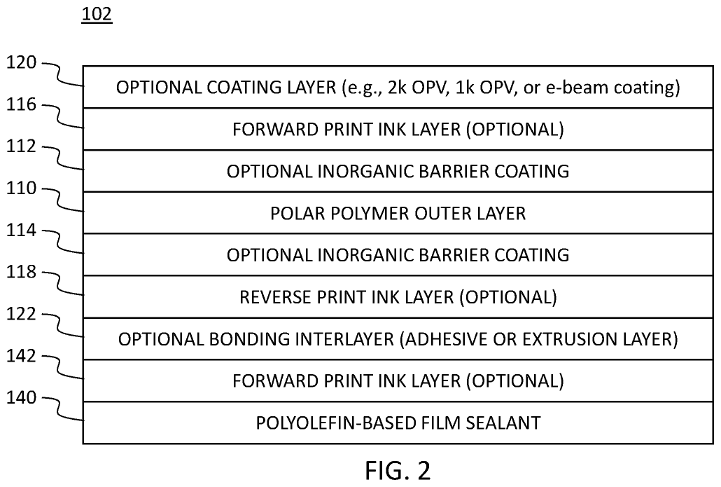

Referring now to FIG. 2, there is shown an exemplary film structure 102 comprising a polar polymer layer 110. An optional inorganic barrier coating 112 may be applied to the outward facing surface of the polar polymer layer 110 and/or an optional inorganic barrier coating 114 may be applied to the inward facing surface of the polar polymer layer 110. An optional printed ink layer 116 (e.g., effected in forward print) may be applied to the outward facing surface of the polar polymer layer 110 and/or an optional printed ink layer 118 (e.g., effected in reverse print) may be applied to the inward facing surface of the polar polymer layer 110. An optional coating layer 120 may be applied as the outermost layer on the polar polymer outer layer 110.

A polyolefin based sealant layer 140 is laminated to the polar polymer outer layer 110 via an optional bonding interlayer 122 disposed intermediate the outer layer 110 and the polyolefin-based sealant film layer 140. In embodiments having the optional bonding interlayer 122 such layer may be an adhesive layer or an extruded polymer interlayer and the structure 102 can be formed using conventional lamination techniques, such as adhesive lamination or extrusion lamination techniques. Alternatively, the optional bonding interlayer 122 is omitted and the polyolefin-based sealant film layer 140 is applied to the inward facing surface of the outer polar polymer film layer 110 via an extrusion or coextrusion coating technique.

The polar polymer layer 110, optional inorganic barrier coating 112, optional inorganic barrier coating 114, optional printed ink layer 116, optional printed ink layer 118, optional coating layer 120, optional bonding interlayer 122, polyolefin-based sealant film layer 140, and optional printed ink layer 142 may be as described above by way of reference to FIG. 1.

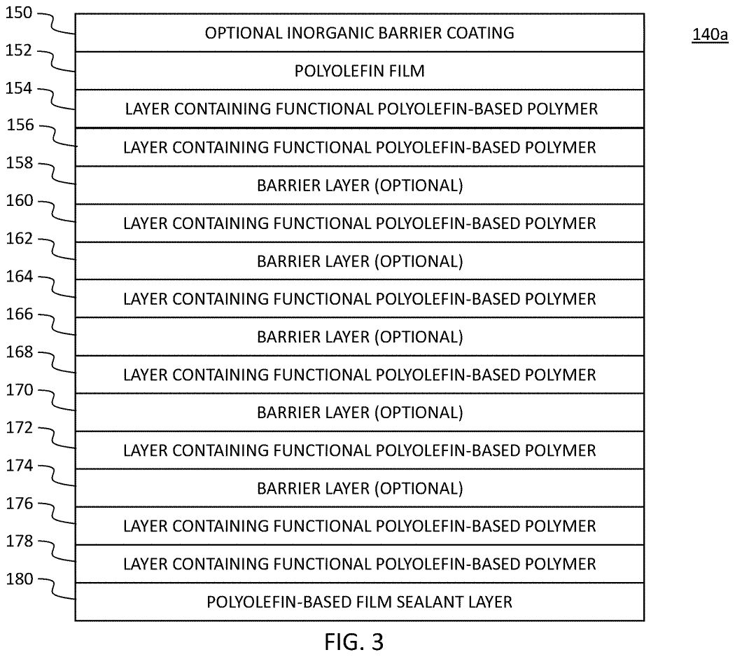

Referring now to FIG. 3, there is shown a film layer 140a, which illustrates an exemplary embodiment of the polyolefin based sealant film layer 140 appearing in FIG. 1 or FIG. 2. The structure 140a comprises a plurality of layers arranged from an outer surface to an inner surface and is illustrated with the outermost layer 150 at the top and the innermost layer 180 at the bottom.

The film structure 140a includes an outer inorganic barrier coating layer 150, a core layer 152, and a sequence of functional and optional barrier layers. Adjacent to the core layer 152 is a first functional layer 154, followed by a second functional layer 156. A first optional barrier layer 158 is disposed between the second functional layer 156 and a third functional layer 160. A second optional barrier layer 162 is positioned between the third functional layer 160 and a fourth functional layer 164. A third optional barrier layer 166 is provided between the fourth functional layer 164 and a fifth functional layer 168. A fourth optional barrier layer 170 is arranged between the fifth functional layer 168 and a sixth functional layer 172. A fifth optional barrier layer 174 is disposed between the sixth functional layer 172 and a seventh functional layer 176. An eighth functional layer 178 is positioned between the seventh functional layer 176 and a polyolefin based sealant layer 180 which is configured to form a heat seal upon application of a sealing temperature and pressure.

The outer inorganic barrier coating layer 150 may be as described above. Each of the functional layers 154, 156, 160, 164, 168, 172, 176, and 178, which may be the same or different, comprises a functional polyolefin based polymer. In embodiments, each of functional layers 154, 156, 1670, 164, 168, 172, 176, 178, which may be the same or different, may comprise a pure functional polyolefin resin or a functional polyolefin resin blended with a polyolefin based polymer. The polyolefin based sealant layer 180 may be formed of a heat sealable polyolefin based polymer as described above.

Each optional barrier layer 158, 162, 166, 170, and 174, which may be the same or different, may be a barrier monolayer or a multilayer structure. In embodiments where the barrier layer is a multilayer structure, it may comprise a core barrier layer, one or more non-barrier layers, and one or more optional tie layers. The tie layers, where present, may be configured to improve adhesion between a barrier monolayer and an adjacent functional layer, and/or to enhance adhesion between a core barrier layer and a non-barrier layer within a multilayer barrier structure.

In embodiments, each optional barrier layer 158, 162, 166, 170, and 174, which may be the same or different, comprises a polymeric oxygen/gas and/or moisture barrier composition, such as polyvinyl alcohol (PVOH), EVOH, and polyamide (PA, e.g., nylon 6, nylon 66, nylon 6/66, nylon 12, and blends and copolymers thereof).

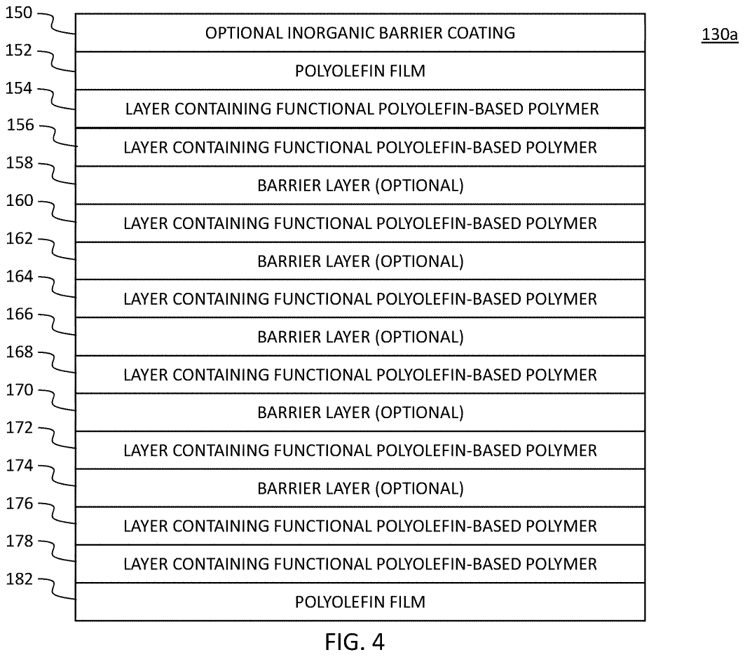

Referring now to FIG. 4, there is shown a film layer 130a, which illustrates an exemplary embodiment of the polyolefin based middle film layer 130 appearing in FIG. 1. The structure 130a is as described above by way of reference to the structure 140a appearing in FIG. 3, except that the innermost heat sealable layer 180 is replaced with a polyolefin based polymer layer 182. The polyolefin based polymer layer 182 need not be heat sealable, although in some embodiments, it may possess heat sealable properties.

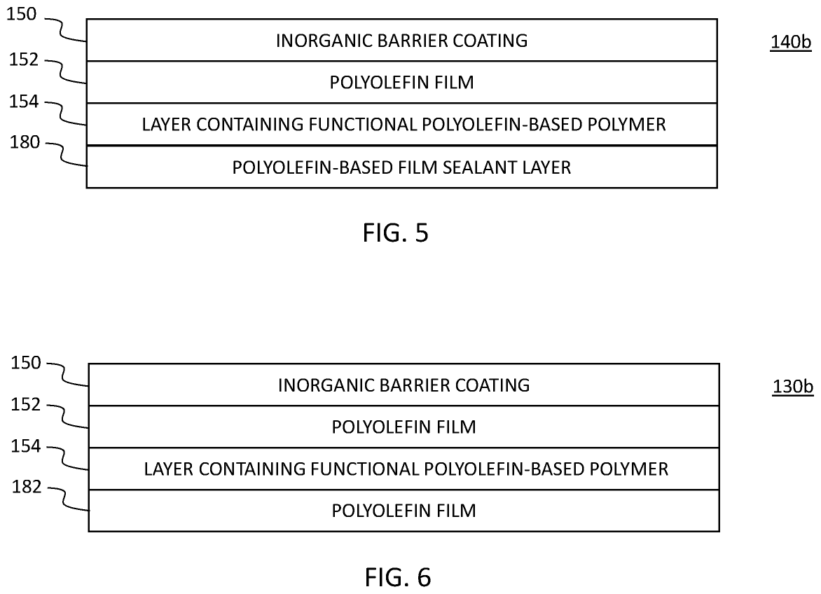

Referring now to FIG. 5, there is shown a film layer 140b, which illustrates another exemplary embodiment of the polyolefin based sealant film layer 140 appearing in FIG. 1 or FIG. 2. The structure 140b comprises a plurality of layers arranged from an outer surface to an inner surface and is illustrated with the outermost layer 150 at the top and the innermost layer 180 at the bottom. The structure 140b comprises an inorganic barrier coating layer 150, a core layer 152, a first functional layer 154, and an innermost heat sealable layer 180, each of which may be as described above.

Referring now to FIG. 6, there is shown a film layer 130b, which illustrates an exemplary embodiment of the polyolefin based middle film layer 130 appearing in FIG. 1. The structure 130b is as described above by way of reference to the structure 140b appearing in FIG. 5, except that the innermost heat sealable layer 180 is replaced with a polyolefin based polymer layer 182. The polyolefin based polymer layer 182 need not be heat sealable, although in some embodiments, it may possess heat sealable properties.

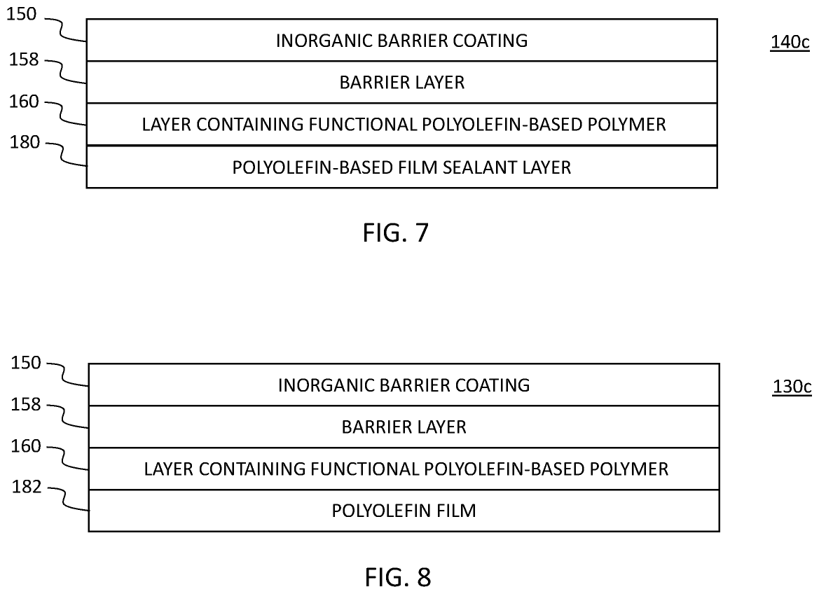

Referring now to FIG. 7, there is shown a film layer 140c, which illustrates another exemplary embodiment of the polyolefin based sealant film layer 140 appearing in FIG. 1 or FIG. 2. The structure 140c comprises an inorganic barrier coating layer 150 adjacent to a barrier layer 158. A functional layer 160 is disposed between the barrier layer 158 and an innermost heat sealable layer 180.

Referring now to FIG. 8, there is shown a film layer 130c, which illustrates an exemplary embodiment of the polyolefin based middle film layer 130 appearing in FIG. 1. The structure 130c is as described above by way of reference to the structure 140c appearing in FIG. 7, except that the innermost heat sealable layer 180 is replaced with a polyolefin based polymer layer 182. The polyolefin based polymer layer 182 need not be heat sealable, although in some embodiments, it may possess heat sealable properties.

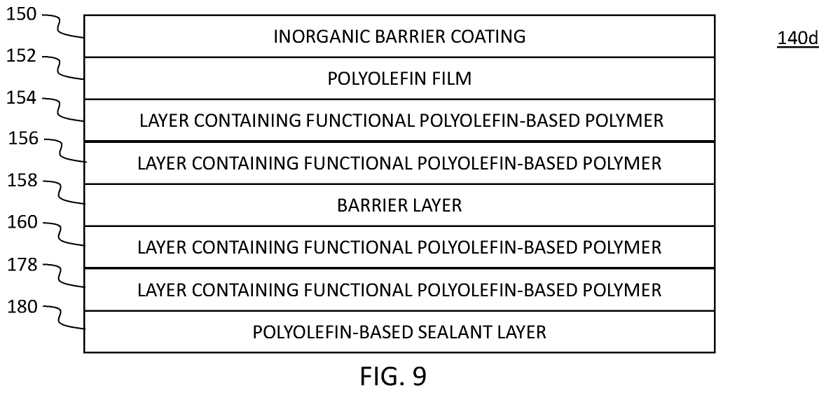

Referring now to FIG. 9, there is shown a film layer 140d, which illustrates another exemplary embodiment of the polyolefin based sealant film layer 140 appearing in FIG. 1 or FIG. 2. The structure 140d comprises an outer inorganic barrier coating layer 150 adjacent to a core layer 152. Adjacent to the core layer 152 is a first functional layer 154, followed by a second functional layer 156. A barrier layer 158 is disposed between the second functional layer 156 and a third functional layer 160. A fourth functional layer 178 is positioned between the third functional layer 160 and a polyolefin based sealant layer 180.

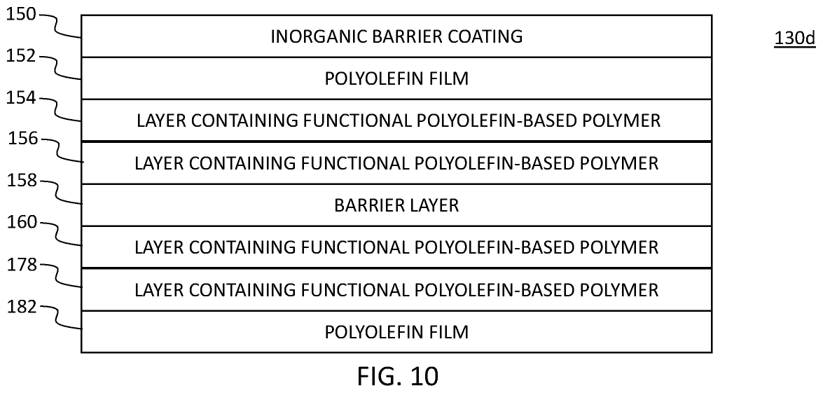

Referring now to FIG. 10, there is shown a film layer 130d, which illustrates an exemplary embodiment of the polyolefin based middle film layer 130 appearing in FIG. 1. The structure 130d is as described above by way of reference to the structure 140d appearing in FIG. 9, except that the innermost heat sealable layer 180 is replaced with a polyolefin based polymer layer 182. The polyolefin based polymer layer 182 need not be heat sealable, although in some embodiments, it may possess heat sealable properties.

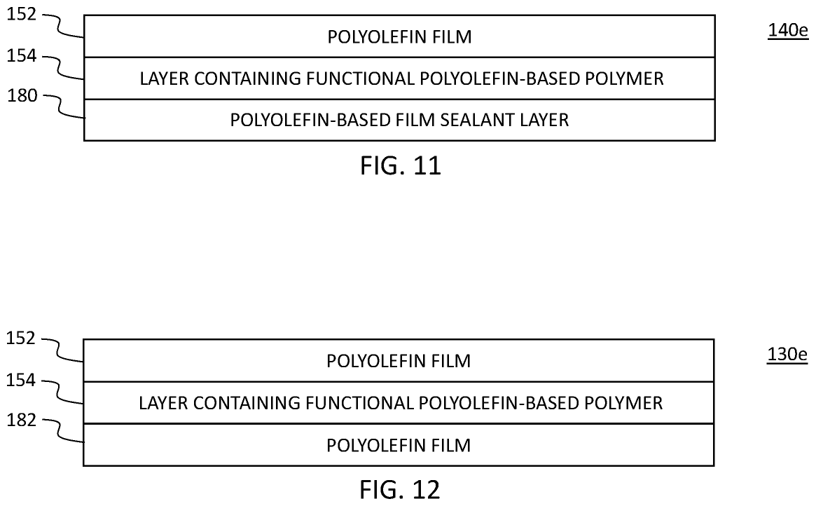

Referring now to FIG. 11, there is shown a film layer 140e, which illustrates another exemplary embodiment of the polyolefin based sealant film layer 140 appearing in FIG. 1 or FIG. 2. The structure 140e comprises a core layer 152 and a functional layer 154 disposed between the core layer 152 and a polyolefin based sealant layer 180.

Referring now to FIG. 12, there is shown a film layer 130e, which illustrates an exemplary embodiment of the polyolefin based middle film layer 130 appearing in FIG. 1. The structure 130e is as described above by way of reference to the structure 140e appearing in FIG. 11, except that the innermost heat sealable layer 180 is replaced with a polyolefin based polymer layer 182. The polyolefin based polymer layer 182 need not be heat sealable, although in some embodiments, it may possess heat sealable properties.

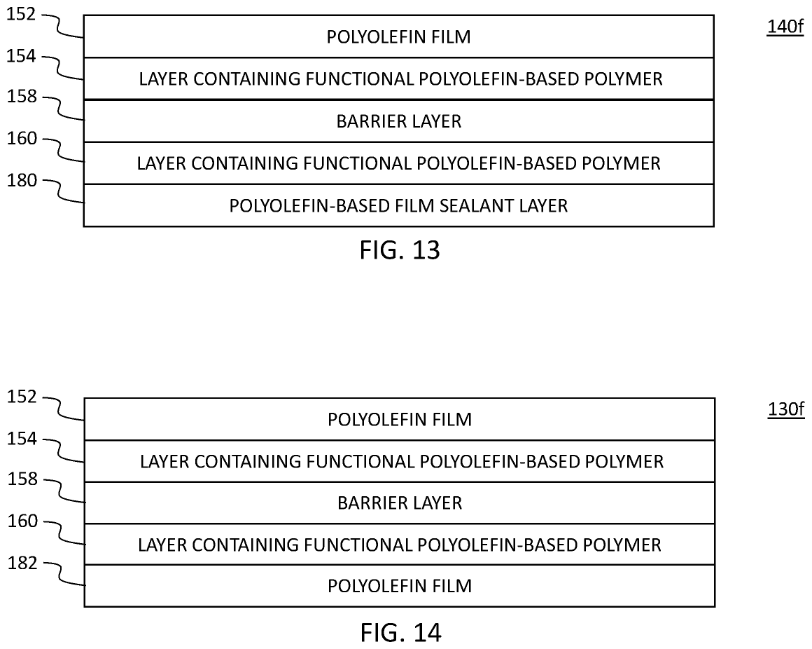

Referring now to FIG. 13, there is shown a film layer 140f, which illustrates another exemplary embodiment of the polyolefin based sealant film layer 140 appearing in FIG. 1 or FIG. 2. The structure 140f comprises an outer core layer 152 adjacent to a first functional layer 154. A barrier layer 158 is disposed between the first functional layer 154 and a second functional layer 160, which is disposed between the barrier layer 158 and a polyolefin based sealant layer 180.

Referring now to FIG. 14, there is shown a film layer 130f, which illustrates an exemplary embodiment of the polyolefin based middle film layer 130 appearing in FIG. 1. The structure 130f is as described above by way of reference to the structure 140f appearing in FIG. 13, except that the innermost heat sealable layer 180 is replaced with a polyolefin based polymer layer 182. The polyolefin based polymer layer 182 need not be heat sealable, although in some embodiments, it may possess heat sealable properties.

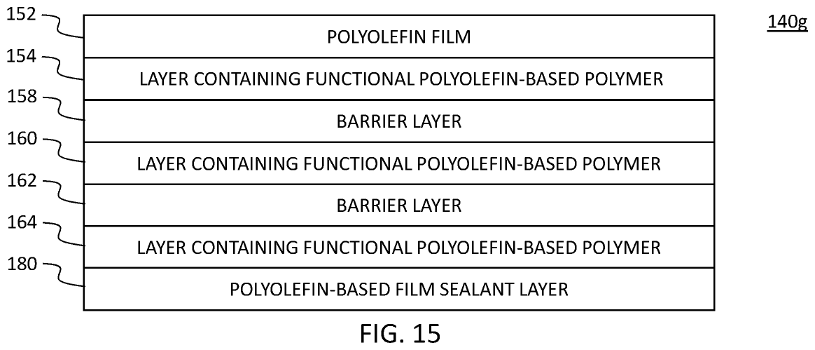

Referring now to FIG. 15, there is shown a film layer 140g, which illustrates another exemplary embodiment of the polyolefin based sealant film layer 140 appearing in FIG. 1 or FIG. 2. The structure 140g comprises an outer core layer 152 adjacent to a first functional layer 154. A first barrier layer 158 is disposed between the first functional layer 154 and a second functional layer 160. A second barrier layer 162 is disposed between the second functional layer 160 and a third functional layer 164. The third functional layer 164 is disposed between the second barrier layer 162 and a polyolefin based sealant layer 180.

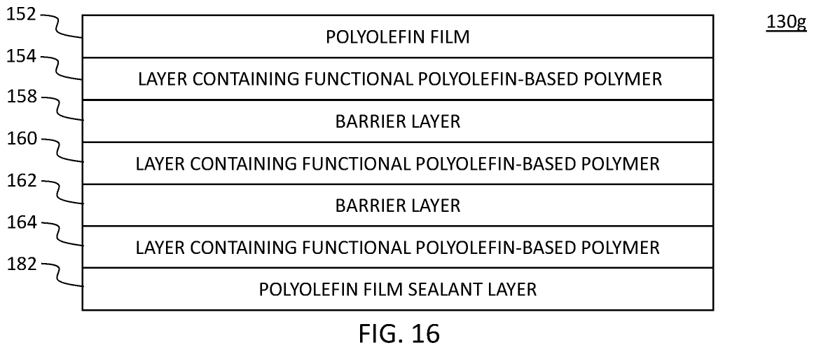

Referring now to FIG. 16, there is shown a film layer 130g, which illustrates an exemplary embodiment of the polyolefin based middle film layer 130 appearing in FIG. 1. The structure 130g is as described above by way of reference to the structure 140g appearing in FIG. 15, except that the innermost heat sealable layer 180 is replaced with a polyolefin based polymer layer 182. The polyolefin based polymer layer 182 need not be heat sealable, although in some embodiments, it may possess heat sealable properties.

In embodiments, the barrier layers 158, 162, 16, 170, 166, 170, and 174 comprise an inorganic barrier layer. in alternative embodiments, the barrier layers 158, 162, 16, 170, 166, 170, and 174 comprise a polymeric oxygen/gas and/or moisture barrier composition, such as polyvinyl alcohol (PVOH), EVOH, polyamide (PA, e.g., nylon 6, nylon 66, nylon 6/66, nylon 12, and blends and copolymers thereof). In embodiments, the barrier layer 226 may comprise a multilayer structure, such as PA/EVOH/PA (with or without optional tie layers) or PA/PVOH/PA (with or without optional tie layers).

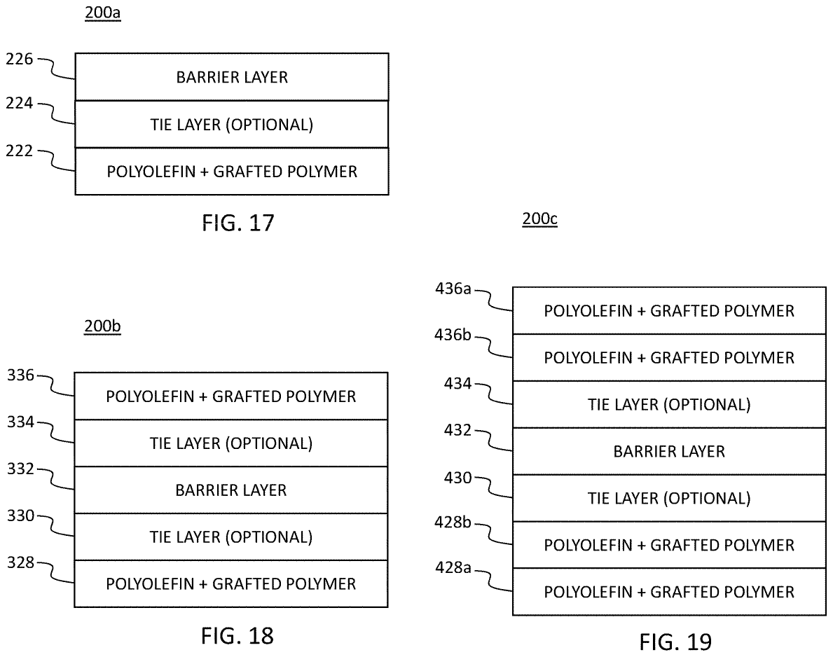

Referring now to FIG. 17, an exemplary multi-layer barrier structure 200a is shown, which may serve as either the sealant layer 140 (see FIGS. 1 and 2) or middle layer 130 (see FIG. 1) of the structures disclosed herein. When the multi-layer barrier structure 200a functions as the sealant layer 140, its innermost surface possesses a heat seal property. Conversely, when the multi-layer barrier structure 200a is positioned as the middle layer 130, its inward-facing surface need not have a heat seal property, although it may in certain embodiments.

The multilayer barrier structure 200a has a structure including a barrier layer 226, a polyolefin-based heat sealable layer 222 with optional functional polymer, and an optional tie resin layer 224 therebetween to promote adhesion between the barrier layer 226 and the sealant layer 222, as follows:

barrier/tie (optional)/polyolefin+functional polymer based polymer (FPB) (optional) wherein the barrier layer is applied facing the middle layer 130 (FIG. 1) or polar outer layer 110 (FIG. 2) and the polyolefin layer optionally admixed with a functional polymer compatibilizer is disposed toward the product facing side of the film 100, 102. In the case of multilayer barrier layers and/or inner sealant layers, optional tie resin layers (“tie”) may be provided to promote adhesion between adjacent layers.

Examples of such multilayer structures operable to embody the structure 200a include:

$$AlOx / PE + FPB ( optional )$$

$$AlOx / PP + FPB ( optional )$$

$$SiOx / PE + FPB ( optional )$$

$$SiOx / PP + FPB ( optional )$$

$$metal / PE + FPB ( optional )$$

$$metal / PP + FPB ( optional )$$

$$EVOH / PE + FPB ( optional )$$

$$EVOH / PP + FPB ( optional )$$

$$EVOH / tie / PE + FPB ( optional )$$

$$EVOH / tie / PP + FPB ( optional )$$

$$PA / PE + FPB ( optional )$$

$$PA / PP + FPB ( optional )$$

$$PA / tie / PE + FPB ( optional )$$

$$PA / tie / PP + FPB ( optional )$$

$$COC / PE + FPB ( optional )$$

$$COC / PP + FPB ( optional )$$

$$COC / tie / PE + FPB ( optional )$$

$$COC / tie / PP + FPB ( optional )$$

$$PA / EVOH / PA / PE + FPB ( optional )$$

$$PA / EVOH / PA / PP + FPB ( optional )$$

$$PA / EVOH / PA / tie / PE + FPB ( optional )$$

$$PA / EVOH / PA / tie / PP + FPB ( optional )$$

$$PA / tie / EVOH / PA / PE + FPB ( optional )$$

$$PA / tie / EVOH / PA / PP + FPB ( optional )$$

$$PA / tie / EVOH / PA / tie / PE + FPB ( optional )$$

$$PA / tie / EVOH / PA / tie / PP + FPB ( optional )$$

$$PA / tie / EVOH / tie / PA / PE + FPB ( optional )$$

$$PA / tie / EVOH / tie / PA / PP + FPB ( optional )$$

$$PA / tie / EVOH / tie / PA / tie / PE + FPB ( optional )$$

$$PA / tie / EVOH / tie / PA / tie / PP + FPB ( optional )$$

$$PA / EVOH / tie / PA / PE + FPB ( optional )$$

$$PA / EVOH / tie / PA / PP + FPB ( optional )$$

$$PA / EVOH / tie / PA / tie / PE + FPB ( optional )$$

$$PA / EVOH / tie / PA / tie / PP + FPB ( optional )$$

$$PA / EVOH / PE + FPB ( optional )$$

$$PA / EVOH / PP + FPB ( optional )$$

$$PA / EVOH / tie / PE + FPB ( optional )$$

$$PA / EVOH / tie / PP + FPB ( optional )$$

$$PA / tie / EVOH / PE + FPB ( optional )$$

$$PA / tie / EVOH / PP + FPB ( optional )$$

$$PA / tie / EVOH / tie / PE + FPB ( optional )$$

$$PA / tie / EVOH / tie / PP + FPB ( optional )$$

$$EVOH / PA / PE + FPB ( optional )$$

$$EVOH / PA / PP + FPB ( optional )$$

$$EVOH / PA / tie / PE + FPB ( optional )$$

$$EVOH / PA / tie / PP + FPB ( optional )$$

$$EVOH / tie / PA / PE + FPB ( optional )$$

$$EVOH / tie / PA / PP + FPB ( optional )$$

$$EVOH / tie / PA / tie / PE + FPB ( optional )$$

$$EVOH / tie / PA / tie / PP + FPB ( optional )$$

$$PVOH / PE + FPB ( optional )$$

$$PVOH / PP + FPB ( optional )$$

$$PVOH / tie / PE + FPB ( optional )$$

$$PVOH / tie / PP + FPB ( optional )$$

$$PA / PVOH / PA / PE + FPB ( optional )$$

$$PA / PVOH / PA / PP + FPB ( optional )$$

$$PA / PVOH / PA / tie / PE + FPB ( optional )$$

$$PA / PVOH / PA / tie / PP + FPB ( optional )$$

$$PA / tie / PVOH / PA / PE + FPB ( optional )$$

$$PA / tie / PVOH / PA / PP + FPB ( optional )$$

$$PA / tie / PVOH / PA / tie / PE + FPB ( optional )$$

$$PA / tie / PVOH / PA / tie / PP + FPB ( optional )$$

$$PA / tie / PVOH / tie / PA / PE + FPB ( optional )$$

$$PA / tie / PVOH / tie / PA / PP + FPB ( optional )$$

$$PA / tie / PVOH / tie / PA / tie / PE + FPB ( optional )$$

$$PA / tie / PVOH / tie / PA / tie / PP + FPB ( optional )$$

$$PA / PVOH / tie / PA / PE + FPB ( optional )$$

$$PA / PVOH / tie / PA / PP + FPB ( optional )$$

$$PA / PVOH / tie / PA / tie / PE + FPB ( optional )$$

$$PA / PVOH / tie / PA / tie / PP + FPB ( optional )$$

$$PA / PVOH / PE + FPB ( optional )$$

$$PA / PVOH / PP + FPB ( optional )$$

$$PA / PVOH / tie / PE + FPB ( optional )$$

$$PA / PVOH / tie / PP + FPB ( optional )$$

$$PA / tie / PVOH / PE + FPB ( optional )$$

$$PA / tie / PVOH / PP + FPB ( optional )$$

$$PA / tie / PVOH / tie / PE + FPB ( optional )$$

$$PA / tie / PVOH / tie / PP + FPB ( optional )$$

$$PVOH / PA / PE + FPB ( optional )$$

$$PVOH / PA / PP + FPB ( optional )$$

$$PVOH / PA / tie / PE + FPB ( optional )$$

$$PVOH / PA / tie / PP + FPB ( optional )$$

$$PVOH / tie / PA / PE + FPB ( optional )$$

$$PVOH / tie / PA / PP + FPB ( optional )$$

$$PVOH / tie / PA / tie / PE + FPB ( optional )$$

$$PVOH / tie / PA / tie / PP + FPB ( optional )$$

Referring now to FIG. 18, there is shown a coextruded a film layer 200b, which illustrates a further exemplary barrier film layer operable to embody the polyolefin-based sealant layer 140 of FIGS. 1 and 2 or the middle layer 130 of FIG. 2. When the multi-layer barrier structure 200b functions as the sealant layer 140, its innermost surface possesses a heat seal property. Conversely, when the multi-layer barrier structure 200b is positioned as the middle layer 130, its inward-facing surface need not have a heat seal property, although it may in certain embodiments.

The film layer 200b comprises a barrier layer 332 coextruded between two polyolefin-based sealant sublayers 328 and 336, each comprising a polyolefin-based polymer, as described above, optionally admixed with a functional polyolefin based polymer, as described above. In embodiments, the barrier layer 332 comprises a polymer selected from PVOH, EVOH, and PA (e.g., nylon 6, nylon 66, nylon 6/66, nylon 12, and blends and copolymers thereof).

Optional tie layers 330, 334 comprising a tie resin may be provided between the adjacent layers 328 and 332 and/or between the adjacent layers 336 and 332 to facilitates adhesion between the layers. Such tie resins may include any suitable tie resin as is known to persons skilled in the for art, including for example, maleic anhydride grafted polyolefins, such as maleic anhydride grafted polyethylene (PE-g-MA), maleic anhydride grafted polypropylene (PP-g-MA), polyethylene-grafted-acrylic acid (PE-g-AA) polypropylene-grafted-acrylic acid (PP-g-AA), ethylene-acrylic acid copolymers (EAA), ethylene-methyl acrylate (EMA) copolymers, ethylene-vinyl acetate copolymer (EVA), ethylene-methacrylic acid copolymer (EMAA), ethylene-butyl acrylate-maleic anhydride terpolymer, and the like.

In certain embodiments, the coextruded a film layer 200b has the following structure, wherein optional tie layers (“tie”) may be provided to promote adhesion between adjacent layers:

$$polyolefin + FPB ( optional ) / barrier / polyolefin + FPB ( optional )$$

Exemplary polyolefins include polyethylene (PE) and polypropylene (PP). Exemplary barriers include ethylene vinyl alcohol copolymer (EVOH) polyvinyl alcohol (PVOH), and/or polyamide (PA). Exemplary polyamides include nylon, such as nylon 6, nylon 66, nylon 6/66, nylon 12, and blends and copolymers thereof. Examples of such film layer 200b include:

$$PE + FPB ( optional ) / EVOH / PE + FPB ( optional )$$

$$PE + FPB ( optional ) / PA / PE + FPB ( optional )$$

$$PP + FPB ( optional ) / EVOH / PP + FPB ( optional )$$

$$PP + FPB ( optional ) / PA / PP + FPB ( optional )$$

$$PE + FPB ( optional ) / tie / EVOH / tie / PE + FPB ( optional )$$

$$PE + FPB ( optional ) / tie / PA / tie / PE + FPB ( optional )$$

$$PP + FPB ( optional ) / tie / EVOH / tie / PP + FPB ( optional )$$

$$PP + FPB ( optional ) / tie / PA / tie / PP + FPB ( optional )$$

$$PE + FPB ( optional ) / PA / EVOH / PA / PE + FPB ( optional )$$

$$PP + FPB ( optional ) / PA / EVOH / PA / PP + FPB ( optional )$$

$$PE + FPB ( optional ) / PA / tie / EVOH / tie / PA / PE + FPB ( optional )$$

$$PP + FPB ( optional ) / PA / tie / EVOH / tie / PA / PP + FPB ( optional )$$

$$PE + FPB ( optional ) / tie / PA / EVOH / PA / tie / PE + FPB ( optional )$$

$$PP + FPB ( optional ) / tie / PA / EVOH / PA / tie / PP + FPB ( optional )$$

$$PE + FPB ( optional ) / tie / PA / tie / EVOH / tie / PA / tie / PE + FPB ( optional )$$

$$PP + FPB ( optional ) / tie / PA / tie / EVOH / tie / PA / tie / PP + FPB ( optional )$$

$$PE + FPB ( optional ) / PVOH / PE + FPB ( optional )$$

$$PP + FPB ( optional ) / PVOH / PP + FPB ( optional )$$

$$PE + FPB ( optional ) / tie / PVOH / tie / PE + FPB ( optional )$$

$$PP + FPB ( optional ) / tie / PVOH / tie / PP + FPB ( optional )$$

$$PE + FPB ( optional ) / PA / PVOH / PA / PE + FPB ( optional )$$

$$PP + FPB ( optional ) / PA / PVOH / PA / PP + FPB ( optional )$$

$$PE + FPB ( optional ) / PA / tie / PVOH / tie / PA / PE + FPB ( optional )$$

$$PP + FPB ( optional ) / PA / tie / PVOH / tie / PA / PP + FPB ( optional )$$

$$PE + FPB ( optional ) / tie / PA / PVOH / PA / tie / PE + FPB ( optional )$$

$$PP + FPB ( optional ) / tie / PA / PVOH / PA / tie / PP + FPB ( optional )$$

$$PE + FPB ( optional ) / tie / PA / tie / PVOH / tie / PA / tie / PE + FPB ( optional )$$

$$PP + FPB ( optional ) / tie / PA / tie / PVOH / tie / PA / tie / PP + FPB ( optional )$$

Referring now to FIG. 19, there is shown a coextruded a film layer 200c, which illustrates an exemplary barrier film layer operable to embody the polyolefin-based sealant layer 140 of FIGS. 1 and 2 or the middle layer 130 of FIG. 2. When the multi-layer barrier structure 200c functions as the sealant layer 140, its innermost surface possesses a heat seal property. Conversely, when the multi-layer barrier structure 200c is positioned as the middle layer 130, its inward-facing surface need not have a heat seal property, although it may in certain embodiments.

The film layer 200c comprises a barrier layer 432 coextruded between dual polyolefin-based inner sealant layers 428a and 428b comprising a polyolefin-based polymer as described above and optionally admixed with a functional polyolefin based polymer as described above and dual polyolefin-based outer sealant layers 436a and 436b comprising a polyolefin-based polymer as described above and optionally admixed with a functional polyolefin based polymer as described above, which are disposed on opposite sides of the barrier layer 432. In embodiments, the barrier layer 432 comprises a polymer selected from PVOH, EVOH, and PA (e.g., nylon 6, nylon 66, nylon 6/66, nylon 12, and blends and copolymers thereof).

Optional tie layers 430, 434 comprising a tie resin may be provided between the adjacent layers 432 and 428b and the adjacent layers 432 and 436b to facilitate adhesion between the layers. Such tie resins may include any suitable tie resin as is known to persons skilled in the for art, including for example, maleic anhydride grafted polyolefins, such as maleic anhydride grafted polyethylene (PE-g-MA), maleic anhydride grafted polypropylene (PP-g-MA), polyethylene-grafted-acrylic acid (PE-g-AA) polypropylene-grafted-acrylic acid (PP-g-AA), ethylene-acrylic acid copolymers (EAA), ethylene-methyl acrylate (EMA) copolymers, ethylene-vinyl acetate copolymer (EVA), ethylene-methacrylic acid copolymer (EMAA), ethylene-butyl acrylate-maleic anhydride terpolymer and the like.

In certain embodiments, the coextruded a film layer 200c has the following structure, wherein optional tie layers (“tie”) may be provided to promote adhesion between adjacent layers:

$$polyolefin + FPB ( optional ) / polyolefin + FPB ( optional ) / barrier / polyolefin + FPB ( optional ) / polyolefin + PFB ( optional )$$

Exemplary polyolefins include polyethylene (PE) and polypropylene (PP). Exemplary barriers include ethylene vinyl alcohol copolymer (EVOH) and/or polyamide (PA). Exemplary polyamides include nylon, such as nylon 6, nylon 66, nylon 6/66, nylon 12, and blends and copolymers thereof. Examples of such film layer 200c include:

$$PE + FPB ( optional ) / PE + FPB ( optional ) / EVOH / PE + FPB ( optional ) / PE + FPB ( optional )$$

$$PE + FPB ( optional ) / PE + FPB ( optional ) / PA / PE + FPB ( optional ) / PE + FPB ( optional )$$

$$PP + FPB ( optional ) / PP + FPB ( optional ) / EVOH / PP + FPB ( optional ) / PP + FPB ( optional )$$

$$PP + FPB ( optional ) / PP + FPB ( optional ) / PA / PP + FPB ( optional ) / PP + FPB ( optional )$$

$$PE + FPB ( optional ) / PE + FPB ( optional ) / tie / EVOH / tie / PE + FPB ( optional ) / PE + FPB ( optional )$$

$$PE + FPB ( optional ) / PE + FPB ( optional ) / tie / PA / tie / PE + FPB ( optional ) / PE + FPB ( optional )$$

$$PP + FPB ( optional ) / PP + FPB ( optional ) / tie / EVOH / tie / PP + FPB ( optional ) / PP + FPB ( optional )$$

$$PP + FPB ( optional ) / PP + FPB ( optional ) / tie / PA / tie / PP + FPB ( optional ) / PP + FPB ( optional )$$

$$PE + FPB ( optional ) / PE + FPB ( optional ) / PA / EVOH / PA / PE + FPB ( optional ) / PE + FPB ( optional )$$

$$PP + FPB ( optional ) / PP + FPB ( optional ) / PA / EVOH / PA / PP + FPB ( optional ) / PP + FPB ( optional )$$

$$PE + FPB ( optional ) / PE + FPB ( optional ) / PA / tie / EVOH / tie / PA / PE + FPB ( optional ) / PE + FPB ( optional )$$

$$PP + FPB ( optional ) / PP + FPB ( optional ) / PA / tie / EVOH / tie / PA / PP + FPB ( optional ) / PP + FPB ( optional )$$

$$PE + FPB ( optional ) / PE + FPB ( optional ) / tie / PA / EVOH / PA / tie / PE + FPB ( optional ) / PE + FPB ( optional )$$

$$PP + FPB ( optional ) / PP + FPB ( optional ) / tie / PA / EVOH / PA / tie / PP + FPB ( optional ) / PP + FPB ( optional )$$

$$PE + FPB ( optional ) / PE + FPB ( optional ) / tie / PA / tie / EVOH / tie / PA / tie / PE + FPB ( optional ) / PE + FPB ( optional )$$

$$PP + FPB ( optional ) / PP + FPB ( optional ) / tie / PA / tie / EVOH / tie / PA / tie / PP + FPB ( optional ) / PP + FPB ( optional )$$

$$PE + FPB ( optional ) / PE + FPB ( optional ) / PVOH / PE + FPB ( optional ) / PE + FPB ( optional )$$

$$PP + FPB ( optional ) / PP + FPB ( optional ) / PVOH / PP + FPB ( optional ) / PP + FPB ( optional )$$

$$PE + FPB ( optional ) / PE + FPB ( optional ) / tie / PVOH / tie / PE + FPB ( optional ) / PE + FPB ( optional )$$

$$PP + FPB ( optional ) / PP + FPB ( optional ) / tie / PVOH / tie / PP + FPB ( optional ) / PP + FPB ( optional )$$

$$PE + FPB ( optional ) / PE + FPB ( optional ) / PA / PVOH / PA / PE + FPB ( optional ) / PE + FPB ( optional )$$

$$PP + FPB ( optional ) / PP + FPB ( optional ) / PA / PVOH / PA / PP + FPB ( optional ) / PP + FPB ( optional )$$

$$PE + FPB ( optional ) / PE + FPB ( optional ) / PA / tie / PVOH / tie / PA / PE + FPB ( optional ) / PE + FPB ( optional )$$

$$PP + FPB ( optional ) / PP + FPB ( optional ) / PA / tie / PVOH / tie / PA / PP + FPB ( optional ) / PP + FPB ( optional )$$

$$PE + FPB ( optional ) / PE + FPB ( optional ) / tie / PA / PVOH / PA / tie / PE + FPB ( optional ) / PE + FPB ( optional )$$

$$PP + FPB ( optional ) / PP + FPB ( optional ) / tie / PA / PVOH / PA / tie / PP + FPB ( optional ) / PP + FPB ( optional )$$

$$PE + FPB ( optional ) / PE + FPB ( optional ) / tie / PA / tie / PVOH / tie / PA / tie / PE + FPB ( optional ) / PE + FPB ( optional )$$

$$PP + FPB ( optional ) / PP + FPB ( optional ) / tie / PA / tie / PVOH / tie / PA / tie / PP + FPB ( optional ) / PP + FPB ( optional )$$

Referring to FIGS. 1 and 2, in certain embodiments wherein the polyolefin-based sealant layer 140 includes a barrier sublayer 226 which is a deposition barrier sublayer (see e.g., barrier layer 226 in FIG. 17), the polyolefin-based sealant layer 140 is laminated to the middle layer 130 (FIG. 1) or the outer layer 110 (FIG. 2) using a bonding interlayer 124 (FIG. 1) or 122 (FIG. 2). Again, the bonding interlayer 124 may take the form of an adhesive layer, which is applied between the layers 140 and 130 (FIG. 1) or between layers 140 and 110 (FIG. 2) via an adhesive lamination process, or an extrusion layer, which is applied between the layers 140 and 130 (FIG. 1) or between layers 140 and 110 (FIG. 2) via an extrusion lamination process.

Referring to FIG. 1, in certain embodiments wherein the polyolefin-based middle layer 130 includes a barrier sublayer 226 which is a deposition barrier sublayer (see e.g., barrier layer 150 in FIGS. 5-10), the polyolefin-based middle layer 130 is laminated to the outer layer 110 using the bonding interlayer 122, which may take the form of an adhesive layer, which is applied between the layers 110 and 130 via an adhesive lamination process, or an extrusion layer, which is applied between the layers 110 and 130 via an extrusion lamination process.

In certain embodiments, wherein the polyolefin-based sealant layer 140 comprises a polymer barrier sublayer (see, e.g., barrier layer 226 in FIG. 17, barrier layer 332 in FIG. 18, and barrier layer 432 in FIG. 19), the polyolefin-based sealant layer 120 may be separately formed and subsequently laminated to the outer layer 110 using the bonding interlayer 122, 124. Again, the bonding interlayer 122, 124 may take the form of an adhesive layer or an extrusion layer as described above.

In certain embodiments, wherein the polyolefin-based sealant layer 140 includes a polymer barrier sublayer (see, e.g., barrier layer 226 in FIG. 17, barrier layer 332 in FIG. 18, and barrier layer 432 in FIG. 19), the polyolefin-based sealant layer may be integrated directly onto the outer layer 110 (FIG. 2) or the middle layer 130 (FIG. 1) as part of a multilayer coextrusion. In such embodiments, the polyolefin-based sealant layer 140 is formed during a coextrusion coating process wherein multiple layers are simultaneously extruded onto the middle layer 130 to form the film structure 100 (see FIG. 1) or, onto the outer layer 110 to form the film structure 102 (see FIG. 2).

For purposes of illustration and ease of exposition, the layers 222 (FIG. 17), 328, 336 (FIG. 18), and layers 428a, 428b, 436a, and 436b (FIG. 19) are described and depicted herein as comprising a polyolefin plus functional polyolefin based polymer. However, it will be understood by those skilled in the art that the composition of the layers is not necessarily limited to this depiction. Each such layer may comprise multiple sublayers wherein one or more of the sublayers may consist of the polyolefin without the functional polymer, provided that the total amount of functional polyolefin based polymer present in the film structure 100 is in the range of 30% to 70% by weight based on the total weight of all polar polymer components in the film structure 100, and more preferably 30% to 55% by weight based on the total weight of all polar polymer components in the film structure 100, including the outer layer 110 as well as any polar polymer components (if any) in the polyolefin based sealant layer 120. The present invention encompasses such variations in layer composition within the scope of the claimed subject matter.

In certain embodiments, the film structures 100, 102 exhibit a recyclability property such that a recycled blended film (as defined below), meets the criteria for recyclability established by a recyclability standards setting organization.

In certain embodiments, the film structures 100, 102 exhibit a recyclability property based on reprocessing compatibility and mechanical property retention after reprocessing, including mechanical property retention in a reprocessed blended material.

In certain embodiments, the film structures 100, 102 exhibit a recyclability property such that a recycled blended film (as defined below) produced from the film structures 100, 102 meets the criteria for recyclability based on critical guidance of the Association of Plastic Recyclers (APR).

In certain embodiments, the film structures 100, 102 exhibit a recyclability property such that when a recycled blended film (as defined below) comprising a reprocessed material derived from the film structures 100, 102 blended with a control resin at a specified ratio, it does not exhibit excessive degradation of one or more mechanical properties in relation to the mechanical properties of a like film produced from solely the control resin, wherein excessive degradation is defined as degradation that exceeds a predetermined threshold.

In certain embodiments, the predetermined threshold for acceptable degradation of one or more mechanical properties in a recycled blended film in relation to the control film is 33%, below which the original film structure meets criteria for recyclability. In certain embodiments, the predetermined threshold for acceptable degradation of one or more mechanical properties in a recycled blended film in relation to the control film is 30%, below which the original film structure meets criteria for recyclability. In certain embodiments, the predetermined threshold for acceptable degradation of one or more mechanical properties in a recycled blended film in relation to the control film is 25%, below which the original film structure meets criteria for recyclability. It will be recognized that the predetermined threshold values set forth above are exemplary and illustrative only and that other thresholds may be selected based on the specific application, testing methodology, industry standards, or applicable recyclability guidelines.

In certain embodiments, the film structures 100, 102 exhibit a recyclability property such that a recycled blended film (as defined below), formed from the film structure 100, demonstrates no more than a 25% decrease in performance in the following tests when compared to a control film (as defined below): (a) dart impact testing, as evaluated in accordance with ASTM D1709; (b) tear resistance in the machine direction (MD), as evaluated in accordance with ASTM D1922; and (c) tear resistance in the transverse direction (TD), as evaluated in accordance with ASTM D1922.

The term “recycled blended film” refers to a film formed by reprocessing the film structure 100 to create a reprocessed material and blending the reprocessed material with a control polymer to produce a recycled blend. The recycled blend is then formed into a recycled blended film. In embodiments, the recycled blend comprises the reprocessed material in an amount ranging from about 20% to about 70% by weight of the recycled blend and a polyolefin-based control polymer in an amount ranging from about 80% to about 30% by weight of the recycled blend. In embodiments, the recycled blend comprises about 50% by weight of the reprocessed material and about 50% by weight of the polyolefin-based control polymer. The term “control film” refers to a film formed entirely of the polyolefin-based control polymer. In embodiments, the polyolefin-based control polymer is virgin polyethylene.

The publication “Association of Plastics Recyclers FPE-CG-01 Critical Guidance Protocol for PE Film and Flexible Recycling,” published by the Association of Plastics Recyclers (APR) is used as a guide for assessing recyclability and re-processability of the films in accordance with the present development. The above protocol calls for evaluating the recyclability and reprocessability of an innovative or test film by reprocessing the test film to produce a reprocessed material. The reprocessed material is then blended with a control resin to create a blended recycled film. This blended recycled film is similar to the control film, except that the control film is composed entirely of the control resin, e.g., virgin polyethylene, without any reprocessed material blended into the resin. The protocol calls for the test film to undergo the following simulated reprocessing, i.e., recycling process.

According to APR critical guidance testing path 1A, the test film is shredded and then densified. Then a blend of 50% by weight control and 50% by weight test material is prepared via dry mixing. In addition, a batch consisting of 100% control material and another batch consisting of 100% test material are also prepared. These three formulations are then fed separately to a pelletizing extruder operating at temperature range of 180-240 deg C. and preferably 200-230 deg C. to produce plastic pellets. The pellets from the compounding extruder are then used to form blown films for characterization. The film blow up ratio (BUR) is targeted at 2.5 with the film thickness of 50 micrometers. The films are evaluated for haze, drop dart impact resistance, and tear resistance in the machine direction (MD) and the transverse direction (TD). The test film is considered re-processable if the mechanical properties of the 50/50 film blend do not decrease by more than 25% as compared to the reprocessed control film.

The film is shredded into strips using a shredding machine. The shredded film then is fed to a densifier which has high speed rotating blade, this machine cuts the plastic strips into smaller pieces and as it rotates at high speed, the smaller piece agglomerate to form a higher density powder suitable for feeding to an extruder. The process can also be done using an agglomerator which cuts and partially melts plastics simultaneously. The output of densifier or agglomerator then is dried at 65-80 deg C. for 12 hours to remove any moisture. Three blends of The dried material then is fed to a single or twin screw extruder that operates at temperatures of 180-240 C and preferably 200-230 C. The extruder is equipped with a pelletizing die and cutting blade resulting in producing plastic pellets from each blend.

Table 2 shows test results obtained from the blown film produced from different blends.

TABLE 2

| | 100% | | |
|---|---|---|---|
| | control | 50/50 | |
| | film | control/test | 100% test |
| MD tear* | 270 | 330 (+22%) | 380 (+40%) |
| (ASTM D1922), | | | |
| TD tear* | 1030 | 970 (−6%) | 925 (−10%) |
| (ASTM D1922), gf | | | |
| Dart Impact* | 90 | 85 (−5%) | 90 0%) |
| (ASTM D1709), gf | | | |

*Unit = gram force (gf)

Based on the test results shown in the table, the film in accordance with the present development is considered to be recyclable as per the APR critical guidance testing criteria.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

1. A puncture resistant, recyclable, polyolefin-based film structure comprising:
at least one polar polymer component, wherein the at least one polar polymer component includes an outer layer comprising an oriented polar polymer film layer, and wherein the outer layer has a maximum puncture force in the range of 15 N to 60 N, in accordance with ASTM F1306;
at least one nonpolar polymer component, wherein the at least one nonpolar polymer component comprises one or more polyolefin-based polymer layers, wherein at least one of the one or more polyolefin-based polymer layers comprises a functional polyolefin based polymer, and wherein the functional polyolefin based polymer is known to the flexible film industry for use as a tie resin for enhancing adhesion between adjacent layers in multilayer structures; and
wherein the functional polyolefin based polymer is further configured to act as a compatibilizer to facilitate compatibility between the at least one polar polymer component and the at least one nonpolar polymer component, wherein the amount of functional polyolefin based polymer in the film structure is in the range of 30% to 70% by weight based on a total weight of the at least one polar polymer component in the film structure.

2. The film structure of claim 1, wherein the amount of functional polyolefin based polymer in the film structure is in the range of 30% to 55% by weight based on a total weight of the at least one polar polymer component in the film structure.

3. The film structure of claim 1, further comprising one or both of:
the film structure exhibits a recyclability property as defined by a recyclability standards setting organization; and
the film meets one or more the recyclability criteria of a recyclability standards-setting organization.

4. (canceled)

5. The film structure of claim 1, wherein the film structure exhibits a recyclability property such that a recycled blended film meets criteria for recyclability established by a recyclability standards setting organization.

6. The film structure of claim 1, wherein the film structure is recyclable as indicated by one or more of:
reprocessing compatibility and mechanical property retention after reprocessing;
mechanical property retention after reprocessing when reprocessed material derived from the film structure is blended with a control resin; and
satisfaction of criteria for recyclability established by the Association of Plastic Recyclers (APR).

7. (canceled)

8. (canceled)

9. The film structure of claim 6, wherein when a recycled blended film comprising a reprocessed material derived from the film structure is blended with a control resin at a specified ratio to produce a reprocessed blended material, a film produced from the reprocessed blended material does not exhibit degradation of one or more mechanical properties exceeding a value selected from the group consisting of:
a prespecified threshold in relation to the mechanical properties of a like film produced from solely the control resin; and
25% in relation to the mechanical properties of a like film produced from solely the control resin.

10. (canceled)

11. The film structure of claim 1, wherein said film structure exhibits a recyclability property based on commercial recycling guidelines specifying that:
when the film structure is reprocessed to form a reprocessed material; and
when the reprocessed material is blended with a control polymer to produce a recycled blend comprising 50% by weight of the reprocessed material and 50% by weight of the control polymer; and
when a blended recycled film is formed from the recycled blend and a control film is formed from the control polymer;
the blended recycled film demonstrates no more than a 25% reduction as compared to the control film in any of:
a. (Original) puncture resistance as evaluated using dart impact testing, in accordance with ASTM D1709;
b. (Original) tear resistance in the machine direction (MD), in accordance with ASTM D1922; and
c. (Original) tear resistance in the transverse direction (TD), in accordance with ASTM D1922.

12. The film structure of claim 1, wherein the functional polyolefin based polymer comprises a functional polymer selected from the group consisting of grafted polymers, block copolymers, random copolymers, alternating copolymers, and any combination thereof.

13. The film structure of claim 1, wherein the functional polyolefin based polymer comprises:
(a) copolymers of alkylenes and vinyl acetate, copolymers of lower alkylenes and vinyl acetate, ethylene vinyl acetate (EVA), vinyl acetate ethylene (VAE), propylene vinyl acetate (PVA), and vinyl acetate propylene (VAP);
(b) copolymers of alkylenes and unsaturated carboxylic acids, copolymers lower alkylenes and lower unsaturated carboxylic acids, ethylene-acrylic acid (EAA) copolymer, ethylene-methacrylic acid (EMAA) copolymer, propylene-acrylic acid copolymer, propylene-methacrylic acid copolymer, butylene-acrylic acid copolymer, and butylene-methacrylic acid copolymer;
(c) copolymers of alkylenes and alkyl esters derived from unsaturated carboxylic acids, copolymers of lower alkylenes and lower alkyl esters derived from lower unsaturated carboxylic acids, ethylene-methyl acrylate copolymer (EMA), ethylene-ethyl acrylate copolymer (EEA), ethylene-propyl acrylate copolymer, ethylene-butyl acrylate copolymer (EBA), propylene-methyl acrylate copolymer, propylene-ethyl acrylate copolymer, propylene-propyl acrylate copolymer, propylene-butyl acrylate copolymer, ethylene-methyl methacrylate copolymer (EMMA), ethylene-ethyl methacrylate copolymer (EEMA), ethylene-propyl methacrylate copolymer, ethylene-butyl methacrylate copolymer (EBAM), propylene-methyl methacrylate copolymer, propylene-ethyl methacrylate copolymer, propylene-propyl methacrylate copolymer, and propylene-butyl methacrylate copolymer;
(d) polyolefins grafted with carboxylic acids or anhydride derivatives, polyolefins grafted with lower carboxylic acids or lower anhydride derivatives, polyethylene (PE) grafted with acrylic acid (AA) (PE-g-AA), polyethylene (PE) grafted with maleic anhydride (MA) (PE-g-MA) polyethylene (PE) grafted with methacrylic acid (MAA) (PE-g-MAA), polypropylene (PP) grafted with acrylic acid (AA) (PP-g-AA), polypropylene (PP) grafted with maleic anhydride (MA) (PP-g-MA), and polypropylene (PP) grafted with methacrylic acid (MAA) (PP-g-MAA);
(e) terpolymers of alkylenes, unsaturated carboxylic acids or alkyl esters derived therefrom, and anhydrides, preferably terpolymers of lower alkylenes, lower unsaturated carboxylic acids or lower alkyl esters derived therefrom, and lower anhydrides, ethylene-butyl acrylate-maleic anhydride terpolymer, ethylene-acrylic acid-maleic anhydride terpolymer, ethylene-methacrylic acid-maleic anhydride terpolymer, ethylene-methyl acrylate-maleic anhydride terpolymer, ethylene-ethyl acrylate-maleic anhydride terpolymer, ethylene-propyl acrylate-maleic anhydride terpolymer, ethylene-methyl methacrylate-maleic anhydride terpolymer, ethylene-ethyl methacrylate-maleic anhydride terpolymer, ethylene-propyl methacrylate-maleic anhydride terpolymer, ethylene-butyl methacrylate-maleic anhydride terpolymer, propylene-acrylic acid-maleic anhydride terpolymer, propylene-methacrylic acid-maleic anhydride terpolymer, propylene-methyl acrylate-maleic anhydride terpolymer, propylene-ethyl acrylate-maleic anhydride terpolymer, propylene-propyl acrylate-maleic anhydride terpolymer, propylene-butyl acrylate-maleic anhydride terpolymer, propylene-methyl methacrylate-maleic anhydride terpolymer, propylene-ethyl methacrylate-maleic anhydride terpolymer, propylene-propyl methacrylate-maleic anhydride terpolymer, propylene-butyl methacrylate-maleic anhydride terpolymer;
(f) a functional polyolefin with at least two different functional groups selected from the group consisting of a carboxylic acid, an ester, an anhydride, an acrylate, an aldehyde, a ketone, an isocyanate, an epoxide, an alkene, an alkyne, and a nitroso group;
(g) any combination of any of the foregoing.

14. The film structure of claim 1, wherein the at least one polar polymer component comprises the oriented polar polymer film layer and optionally one or more polymer barrier layer in the polyolefin-based sealant layer.

15. The film structure of claim 1, wherein the outer layer comprises a film selected from the group consisting of biaxially oriented nylon (BON), cast nylon, oriented polyethylene terephthalate (OPET), and biaxially oriented polyethylene terephthalate (BOPET).

16. The film structure of claim 1, further comprising a bonding interlayer selected from the group consisting of an adhesive layer and an extrusion interlayer, the bonding interlayer disposed intermediate the outer layer and the polyolefin-based sealant layer.

17. The film structure of claim 1, further comprising any one or more of:
the one or more polyolefin-based polymer layers includes a polyolefin-based sealant layer having an inner sealant layer and at least one intermediate film layer disposed between the oriented polar polymer film layer and the inner sealant layer;
the polyolefin-based sealant layer comprises an inner sealant layer and optionally one or more barrier layer disposed between the oriented polar polymer film layer and the inner sealant layer;
the polyolefin-based sealant layer comprises an inner sealant layer and one or more barrier layers disposed between the oriented polar polymer film layer and the inner sealant layer wherein the barrier layer is selected from the group consisting of an inorganic barrier layer and a polymeric barrier layer;
the polyolefin-based sealant layer comprises an inner sealant layer and one or more barrier layers disposed between the oriented polar polymer film layer and the inner sealant layer wherein the barrier layer is selected from the group consisting of an aluminum oxide (AlOx) coating layer, a silicon oxide (SiOx) coating layer, and a metallized deposition layer; and
the polyolefin-based sealant layer comprises an inner sealant layer and one or more barrier layers disposed between the oriented polar polymer film layer and the inner sealant layer wherein the barrier layer is selected from the group consisting of a polyvinyl alcohol (PVOH) layer, an ethylene vinyl alcohol copolymer (EVOH) layer, a polyamide layer, and any combination thereof.

18. (canceled)

19. (canceled)

20. (canceled)

21. (canceled)

22. The film structure of claim 1, wherein the one or more polyolefin-based polymer layers includes a polyolefin-based sealant layer comprising an inner sealant layer, an outer sealant layer, and optionally one or more barrier layers disposed between the inner sealant layer and the outer sealant layer.

23. (canceled)

24. The film structure of claim 1, wherein the one or more polyolefin-based polymer layers comprises a polymer selected from the group consisting of polyethylene (PE), polypropylene (PP), polybutene (PB), polyolefin blends, polyolefin copolymers, low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cyclic olefin copolymer (COC), cast polypropylene (CPP), ethylene-propylene copolymer (EPC), monoaxially- and biaxially-oriented polyolefins, biaxially oriented polypropylene (BOPP), and other polyolefin materials, post-consumer recycled (PCR) polyolefins, as well as blends, coextrusions, and laminations of any of the foregoing.

25. The film structure of claim 1, wherein the one or more polyolefin-based polymer layers includes a polymer coextrusion comprising:
a first coextrusion layer comprising a polyolefin polymer;
a second coextrusion layer comprising a polyolefin polymer; and
a coextrusion barrier layer disposed intermediate the first and second coextrusion layers.

26. The film structure of claim 25, wherein the functional polyolefin based polymer is admixed with at least one of the first coextrusion layer and the second coextrusion layer.

27. The film structure of claim 26, further comprising a first tie layer disposed intermediate the first coextrusion layer and the coextrusion barrier layer and a second tie layer disposed intermediate the second coextrusion layer and the coextrusion barrier layer.

28. The film structure of claim 25, wherein the coextrusion barrier layer comprises one or more polymers selected from the group consisting of polyvinyl alcohol (PVOH), ethylene vinyl alcohol copolymer (EVOH), and nylon.

29. The film structure of claim 1, wherein the functional polyolefin based polymer comprises a functional polyolefin with at least one functional group selected from the group consisting of a carboxylic acid, an ester, an anhydride, an aldehyde, a ketone, an isocyanate, an epoxide, an acrylate, an alkene, an alkyne, a nitroso, an imide, a carbonate, a nitrile, an acid halide, a phosphoric acid derivative, an alkyl halide, a sulfonyl halide, an aziridine, a halogen, a carbene, and a sulfonic acid group.

30. (canceled)

31. A packaging article formed of the film structure according to claim 1.
